(19) United States
(12) Patent Application Publication
(10) Pub. No.: US 2026/0252935 A1
(43) Pub. Date: Aug. 27, 2026

(54) SYSTEMS AND METHODS FOR SPATIAL, TEMPORAL, AND VECTORIAL QUANTUM SENSING

(71) Applicant: The MITRE Corporation, McLean, VA (US)

(72) Inventors: Nima LECLERC, Boston, MA (US); Mark DONG, Somerville, MA (US)

(73) Assignee: The MITRE Corporation, McLean, VA (US)

(21) Appl. No.: 19/455,548

(22) Filed: Jan. 21, 2026

Related U.S. Application Data
(60) Provisional application No. 63/762,524, filed on Feb. 24, 2025.

(51) Int. Cl. G06N 10/40

(52) U.S. Cl. CPC G06N 10/40

(57) ABSTRACT

A method for determining at least one characteristic of an electromagnetic signal using a quantum probe, the method including determining a resonant frequency of at least one qubit of at least one quantum probe, applying at least one pulse sequence to the at least one qubit, wherein the at least pulse sequence has a carrier frequency of the resonant frequency and is associated with a filter function that comprises an orthonormal basis, capturing a plurality of images associated with electromagnetic radiation emitted by the at least one qubit after applying the at least one pulse sequence to the at least one qubit, and determining at least one characteristic of the electromagnetic signal based on the plurality of images.

### CROSS-REFERENCE TO RELATED APPLICATIONS

This application claims the benefit of U.S. Provisional Application No. 63/762,524 filed Feb. 24, 2025, the entire contents of which are incorporated herein by reference.

### FIELD

This application relates generally to quantum sensing, and more specifically to systems and methods for spatial, temporal, and vectorial quantum sensing of electromagnetic signals.

### BACKGROUND

Quantum sensing systems may determine aspects of a physical system by manipulating and monitoring qubits subject to the physical system. For instance, quantum sensing systems may determine a spatial, vectorial, or temporal characteristic of an electromagnetic signal produced by a variety of physical systems, like neurons, electric circuits, magnetic rocks, proteins, etc. The quantum sensing systems may determine characteristics of an electromagnetic signal by applying a pulse sequence to a quantum probe while the electromagnetic signal is present (e.g., while the electromagnetic signal to be sensed is present). The application of the pulse sequence causes the qubits of the quantum probe to accumulate phase or shift their resonant frequencies according to the electromagnetic signal. The accumulated phase or the shifts of the resonant frequencies is then measured by capturing electromagnetic radiation emitted by the qubits. For instance, a quantum sensing system may apply a conventional pulse sequence, such as Ramsey, Hahn-Echo, or dynamical decoupling (DD), to a quantum probe, such as a diamond solid-state host, to cause nitrogen vacancy center defects in the diamond solid-state host to accumulate phase according to the electromagnetic signal. The accumulated phase may then be captured by measuring the magnitude of visible light emitted by the nitrogen vacancy center defects.

Quantum sensing systems that use conventional pulse sequences can determine some, but not all, characteristics of an unknown and arbitrary electromagnetic signal. For instance, quantum sensing systems that use a Ramsey pulse sequence can only detect the spatial and vectorial characteristics of a direct current (DC) electromagnetic signal. Quantum sensing systems that can detect temporal characteristics of a time-varying electromagnetic signal, such as those that use Hahn-Echo or DD pulse sequences, may benefit from a priori knowledge of the electromagnetic signal's frequency (e.g., the signal cannot be unknown) and/or a monochromatic signal (e.g., the signal cannot be arbitrary). As such, quantum sensing with conventional pulse sequences may be limiting for applications in which determination of the spatial, vectorial, and temporal characteristics of an unknown and arbitrary electromagnetic signal is needed.

### SUMMARY

According to an aspect, quantum sensing systems and methods determine characteristics (e.g., spatial, temporal, and/or vectorial characteristics) of an arbitrary and unknown electromagnetic signal using orthonormal electromagnetic field pulse sequences applied to one or more qubits. Images of electromagnetic radiation emission (e.g., red light emitted by one or more nitrogen vacancy center defects of a diamond solid-state host) of the one or more qubits resulting from the orthonormal electromagnetic field pulse sequences and the electromagnetic signal are processed to reconstruct the magnetic field component of the electromagnetic signal. The characteristics (e.g., spatial, temporal, and/or vectorial characteristics) of the arbitrary and unknown electromagnetic signal are determined from the reconstructed magnetic field component of the electromagnetic signal. The orthonormal electromagnetic field pulse sequences may be generated with one or more carrier frequencies associated with one or more crystallographic orientations of the one or more qubits in the one or more quantum probes and according to filter functions from a basis that is orthonormal in time (or frequency). An exemplary filter function is a Walsh function, and the basis that is orthonormal in time (or frequency) of the orthonormal electromagnetic field pulse sequences may be a Walsh basis.

Unlike conventional pulse sequences, applying orthonormal electromagnetic field pulse sequences, as disclosed herein, to the qubits causes the qubits to accumulate phase representing a projection of the electromagnetic signal (e.g., along a crystallographic orientation of the qubits) onto the filter function (e.g., phase measurement associated with the coefficients of the filter function). This accumulated phase is represented in the electromagnetic radiation emitted from the qubits, such that capturing images of the emitted electromagnetic radiation captures the accumulated phase of the qubits. Successive application of the orthonormal pulse sequences and image capture by a camera system in accordance with triggering the electromagnetic signal, such that at least one characteristic of the electromagnetic signal is consistent for each triggering, yields a set of images that capture phase measurements associated with coefficients of the filter functions. Linearly combining the set of images (e.g., combining the phase measurements associated with coefficients of the filter functions) using a control system yields an approximation of the spatial and temporal profile of the magnetic field component of the electromagnetic signal along the crystallographic orientation of the qubits. The approximation of the spatial and temporal profile of the magnetic field component of the electromagnetic signal can be used to determine the spatial, temporal, and vectorial characteristics of the electromagnetic signal, without requiring a priori knowledge of the signal (e.g., unknown signal) and/or a monochromatic signal (e.g., arbitrary signal).

According to some examples, a method for determining at least one characteristic of an electromagnetic signal using a quantum probe, the method including determining a resonant frequency of at least one qubit of at least one quantum probe, applying at least one pulse sequence to the at least one qubit, wherein the at least pulse sequence has a carrier frequency of the resonant frequency and is associated with a filter function that includes an orthonormal basis, capturing a plurality of images associated with electromagnetic radiation emitted by the at least one qubit after applying the at least one pulse sequence to the at least one qubit, and determining at least one characteristic of the electromagnetic signal based on the plurality of images.

In any of these examples, the orthonormal basis including the filter function is a Walsh basis. In any of these examples, adjusting at least one parameter of the at least one pulse sequence using an optimization algorithm. In any of these examples, adjusting the at least one parameter of the at least one pulse sequence tunes a spatial uniformity of the at least one pulse sequence applied to the at least one qubit. In any of these examples, adjusting the at least one parameter of the at least one pulse sequence tunes a sensitivity of the at least one qubit to the electromagnetic signal.

In any of these examples, the plurality of images is captured by a lock-in camera. In any of these examples, the plurality of images captured by the lock-in camera include an image associated with a positive in-phase phase, an image associated with a negative in-phase phase, an image associated with a positive quadrature phase, and an image associated with a negative quadrature phase.

In any of these examples, adjusting at least one parameter of the at least one pulse sequence to tune at least one portion of an image using reinforcement learning. In any of these examples, the at least one characteristic of the electromagnetic signal includes a spatial characteristic, a temporal characteristic, and a vectorial characteristic.

In any of these examples, the electromagnetic signal is unknown and arbitrary. In any of these examples, triggering the electromagnetic signal in correspondence with application of the at least one pulse sequence. In any of these examples, repeatedly triggering the electromagnetic signal using at least one characteristic that is consistent for different triggerings of the electromagnetic signal. In any of these examples, the at least one characteristic of the electromagnetic signal that is consistent for different triggerings of the electromagnetic signal includes an amplitude characteristic or a phase characteristic.

In any of these examples, the at least one quantum probe includes at least one diamond solid-state host. In any of these examples, the at least one qubit of the at least one diamond solid-state host includes at least one nitrogen vacancy center defect, at least one silicon vacancy defect, or at least one tin vacancy defect.

According to some examples, a system for determining at least one characteristic of an electromagnetic signal, the system including at least one qubit of at least one quantum probe, wherein the at least one qubit has a resonant frequency, an electromagnetic field generator configured to apply at least one pulse sequence to the at least one qubit, wherein the at least one pulse sequence has a carrier frequency of the resonant frequency and is associated with a filter function that includes an orthonormal basis, a camera system configured to capture a plurality of images associated with electromagnetic radiation emitted by the at least one qubit after applying the at least one pulse sequence to the at least one qubit, and a control system configured to control the electromagnetic field generator to apply the at least one pulse sequence to the at least one qubit, control the camera system to capture the plurality of images, receive the plurality of images from the camera system, and determine at least one characteristic of the electromagnetic signal based on the plurality of images received.

In any of these examples, the orthonormal basis including the filter function is a Walsh basis. In any of these examples, the control system is configured to adjust at least one parameter of the at least one pulse sequence based on an output of an optimization algorithm. In any of these examples, adjusting the at least one parameter of the at least one pulse sequence tunes a spatial uniformity of the at least one pulse sequence applied to the at least one qubit. In any of these examples, adjusting the at least one parameter of the at least one pulse sequence tunes a sensitivity of the at least one qubit to the electromagnetic signal.

In any of these examples, the camera system includes a lock-in camera. In any of these examples, the plurality of images captured by the lock-in camera include an image associated with a positive in-phase phase, an image associated with a negative in-phase phase, an image associated with a positive quadrature phase, and an image associated with a negative quadrature phase. In any of these examples, the control system is configured to adjust at least one parameter of the at least one pulse sequence based on an output from reinforcement learning, wherein adjusting the at least one parameter tunes at least one portion of an image.

In any of these examples, the at least one characteristic of the electromagnetic signal determined by the control system includes a spatial characteristic, a temporal characteristic, and a vectorial characteristic. In any of these examples, triggering the electromagnetic signal in correspondence with application of the at least one pulse sequence. In any of these examples, repeatedly triggering the electromagnetic signal using at least one characteristic that is consistent for different triggerings of the electromagnetic signal. In any of these examples, the at least one characteristic of the electromagnetic signal that is consistent for different triggerings of the electromagnetic signal includes an amplitude characteristic or a phase characteristic.

In any of these examples, the at least one quantum probe includes at least one diamond solid-state host. In any of these examples, the at least one qubit of the diamond solid-state host includes at least one nitrogen vacancy center defect, at least one silicon vacancy defect, or at least one tin vacancy defect.

### BRIEF DESCRIPTION OF THE DRAWINGS

The invention will now be described, by way of example only, with the reference to the accompanying drawings, in which:

FIG. 1A illustrates a quantum sensing system for determining at least one characteristic of an electromagnetic signal, according to some examples;

FIG. 1B is a functional block diagram of a control system, according to some examples;

FIG. 2A illustrates a nitrogen vacancy center defect (e.g., qubit) of a diamond solid-state host (e.g., quantum probe), according to some examples;

FIG. 2B illustrates an energy level structure of nitrogen vacancy center defects of a diamond solid-state host, according to some examples;

FIG. 3 illustrates a quantum sensing system for determining at least one characteristic of an electromagnetic signal using at least one nitrogen vacancy center defect and at least one orthonormal electromagnetic field pulse sequence generated according to a Walsh basis, according to some examples;

FIG. 4 illustrates an approximation of the magnetic field component of an electromagnetic signal of a single pixel from a plurality of pixels, according to some examples;

FIG. 5 illustrates a quantum sensing process utilizing at least one nitrogen vacancy center with a k crystallographic orientation, according to some examples;

FIG. 6 illustrates a pulse sequence that includes a Walsh function with a Walsh order i, according to some examples;

FIG. 7 illustrates a quantum sensing process utilizing a plurality of k crystallographic orientations of at least one nitrogen vacancy center defect, according to some examples;

FIG. 8 plots inverse sensitivity versus an electromagnetic signal's frequency for a plurality of quantum sensing processes, according to some examples;

FIG. 9A illustrates a spatially optimized electromagnetic field generator, according to some examples;

FIG. 9B illustrates a spatial uniformity of an electromagnetic field induced by a current of magnitude 150 mA applied to a spatially optimized electromagnetic field generator, according to some examples;

FIG. 10 illustrates a second spatially optimized electromagnetic field generator with a plurality of current traces, according to some examples;

FIG. 11 illustrates a reinforcement learning algorithm used to optimize a per-pixel sensitivity, according to some examples;

FIG. 12A illustrates an exemplary method for determining at least one characteristic of an electromagnetic signal, according to some examples;

FIG. 12B illustrates an exemplary method for determining one or more resonant frequencies of at least one qubit, according to some examples;

FIG. 12C illustrates an exemplary method for determining a Rabi frequency of at least one qubit, according to some examples;

FIG. 13 illustrates an exemplary computing system, according to some examples.

### DETAILED DESCRIPTION

Disclosed herein are examples of quantum sensing systems and methods that utilize orthonormal electromagnetic field pulse sequences to determine characteristics of an arbitrary and unknown electromagnetic signal. The orthonormal electromagnetic field pulse sequences may be generated with one or more carrier frequencies of one or more crystallographic orientations of qubits in one or more quantum probes and according to filter functions from a basis that is orthonormal in time (or frequency). For instance, the basis that is orthonormal in time (or frequency) may be a Walsh basis that includes Walsh functions (e.g., filter functions) that are digital square pulses of value ±1. Images of emission of the qubits resulting from accumulated phase representing the projection of the electromagnetic signal onto the filter functions (e.g., phase measurements associated with coefficients of the filter functions) of the orthonormal electromagnetic field pulse sequences are captured and combined to reconstruct the magnetic field component of the electromagnetic signal. At least one characteristic of the arbitrary and unknown electromagnetic signal is determined from the reconstructed electromagnetic signal.

According to various embodiments, the quantum sensing systems and methods may determine at least one characteristic (e.g., spatial characteristic, temporal characteristic, and/or vectorial characteristic) of the arbitrary and unknown electromagnetic signal by initializing at least one qubit, such as nitrogen vacancy center defects, of at least one quantum probe, such as a diamond solid-state host, to a first quantum state and applying an orthonormal electromagnetic field pulse sequence to the at least one qubit of the at least one quantum probe. The application of the orthonormal electromagnetic field pulse sequence rotates the at the least one qubit while the at least one qubit accumulates phase representing the projection of the electromagnetic signal onto the filter function inherent to the orthonormal electromagnetic field pulse sequence (e.g., phase measurement associated with a coefficient of the filter function). A control system controls an electromagnetic field generator to apply the orthonormal electromagnetic field pulse sequence to the at least one qubit. The control system, after the application of the orthonormal electromagnetic field pulse sequence, triggers emission of electromagnetic radiation, which represents the accumulated phase, from the at least one qubit by illuminating the at least one qubit with light. The control system triggers a camera system to capture one or more images of the emitted electromagnetic radiation in accordance with the triggering of the emission of the electromagnetic radiation.

Successive application of the orthonormal electromagnetic field pulse sequences and image capture yields a set of images, or a set of phase measurements associated with coefficients of the filter functions. The successive orthonormal electromagnetic field pulse sequences may be generated according to the same, or different, filter functions and/or the same, or different, carrier frequencies. Linearly combining the set of images (e.g., combining the emitted electromagnetic radiation representing the phase measurements associated with the coefficients of the filter functions) associated with the basis that is orthonormal in time (or frequency) using a control system yields an approximation of the spatial and temporal profile of the magnetic field component of the electromagnetic signal along one or more crystallographic orientations of the at least one qubit of the at least one quantum probe (e.g., a movie depicting the spatial temporal profile of the magnetic field component of the electromagnetic signal along one or more crystallographic orientations of the at least one qubit). The approximation improves as the size of the set of images increases. The control system uses the approximation to determine at least one characteristic of the electromagnetic signal.

According to various embodiments, a quantum sensing system includes at least one quantum probe with at least one qubit and an electromagnetic field generator configured to apply at least one orthonormal electromagnetic field pulse sequence to the at least one quantum probe. The quantum sensing system may include the camera system configured to capture one or more images of the electromagnetic radiation emitted from the at least one qubit. The quantum sensing system may include the control system. The control system may be configured to generate at least one pulse sequence for and provide to the electromagnetic field generator, control the camera system, receive the one or more images captured by the camera system, approximate the magnetic field component of the electromagnetic signal using the one or more images and a reconstruction equation, and determine at least one characteristic of the electromagnetic signal using the approximated magnetic field component of the electromagnetic signal.

Compared to quantum sensing methods and systems using conventional pulse sequences, such as continuous wave optically detected magnetic resonance (CW-ODMR), Ramsey, DD, Hahn-Echo, Rabi, etc., the quantum sensing systems and methods disclosed herein may determine the spatial, vectorial, and temporal characteristics of an unknown and arbitrary electromagnetic signal. The vectorial characteristic of the electromagnetic signal may be determined by using orthonormal electromagnetic field pulse sequences having a plurality of carrier frequencies (e.g., plurality of quantum state frequencies), such that each carrier frequency may represent a different crystallographic orientation of the at least one qubit of the at least one quantum probe. The temporal and spatial characteristic may be determined by combining the set of images representing the phase measurements associated with the coefficients of the filter functions, thus reconstructing the temporal profile of the electromagnetic signal across a field-of-view of a camera in the camera system.

The quantum sensing systems and methods disclosed herein may have greater sensitivity to the electromagnetic signal (e.g., may determine an electromagnetic signal with a smaller amplitude) than quantum sensing systems and methods utilizing conventional pulse sequences because at least one spatial-temporal optimization may be used to optimize for spatial uniformity and sensitivity. For instance, the at least one spatial-temporal optimization may be performed by an optimization algorithm and/or reinforcement learning, and the output(s) may tune a spatial uniformity characteristic (e.g., spatial uniformity of the at least one orthonormal electromagnetic field pulse sequence applied to the at least one quantum probe) and/or sensitivity characteristic (e.g., sensitivity of the quantum sensing systems and methods to the electromagnetic signal). In some examples, an optimization algorithm may minimize a cost function, and the output(s) may be used to adjust at least one parameter of the at least on orthonormal electromagnetic field pulse sequence. In some examples, reinforcement learning may iteratively learn a policy that optimizes the sensitivity. The output(s) of the reinforcement learning may be used to adjust at least one parameter of the at least one pulse sequence (e.g., pulse shape, pulse timing, etc.), thus tuning one or more portions of the one or more images capturing the emitted electromagnetic radiation. As such, the quantum sensing systems and methods described herein may determine the spatial, temporal, and/or vectorial characteristics of arbitrary and unknown electromagnetic signals and may have greater sensitivity to the arbitrary and unknown electromagnetic signals due to the spatial-temporal optimization performed by an optimization algorithm and/or reinforcement learning.

The following description sets forth exemplary systems, parameters, and the like. It should be recognized, however, that such description is not intended as a limitation on the scope of the present disclosure but is instead provided as a description of exemplary embodiments.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise, as apparent from the following discussion, it is appreciated that, throughout the description, discussions utilizing terms such as “processing,” “computing,” “calculating,” “determining,” “displaying,” “generating,” or the like, refer to the action and processes of a computer system, or similar electronic computing device, that manipulates and transforms data represented as physical (electronic) quantities within the computer system memories or registers or other such information storage, transmission, or display devices.

The present disclosure, in some aspects, also relates to devices or systems for performing the operations herein. The devices or systems may be specially constructed for the required purposes, may comprise a general-purpose computer selectively activated or reconfigured by a computer program stored in the computer, or may include any combination thereof. Computer instructions for performing the operations herein can be stored in any combination of non-transitory, computer-readable storage media, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, or any type of media suitable for storing electronic instructions, and each coupled to a computer system bus. One or more instructions for performing the operations herein may be implemented in or executed by one or more Application Specific Integrated Circuits (ASICs), Field Programmable Gate Arrays (FPGAs), Digital Signal Processing units (DSPs), Graphics Processing Units (GPUs), or Central Processing Units (CPUs). Furthermore, the computers referred to herein may include a single processor or may be architectures employing multiple processor designs for increased computing capability.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

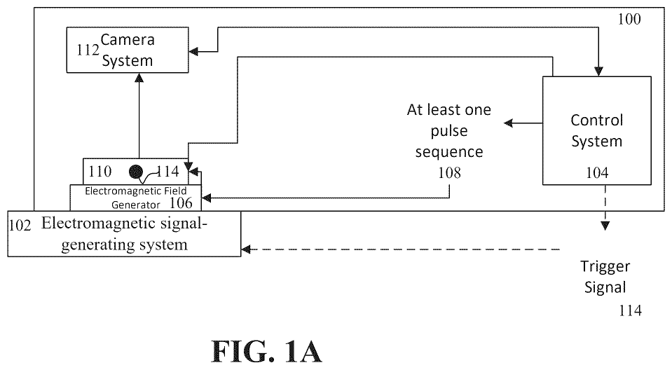

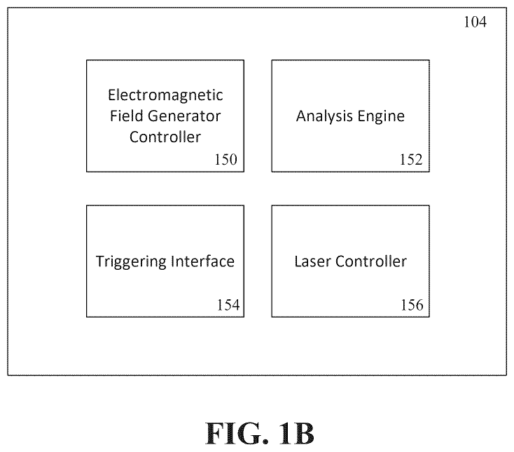

The quantum sensing methods and systems described herein may be used to determine at least one characteristic (e.g., spatial, temporal, and/or vectorial characteristic) of an electromagnetic signal. In some examples, the electromagnetic signal is unknown (e.g., a frequency of the electromagnetic signal is not known a priori) and/or arbitrary (e.g., the electromagnetic signal includes a plurality of frequencies). FIG. 1A illustrates an exemplary quantum sensing system 100 configured to determine characteristics of an electromagnetic signal generated by an electromagnetic signal-generating system 102. The electromagnetic signal-generating system 102 may be any system that can produce an electromagnetic signal, and the electromagnetic signal may be an electromagnetic field. For instance, the electromagnetic signal-generating system 102 may be an electrical (e.g., microelectronic), chemical (e.g., chemical composition, chemical reaction), geological (e.g., magnetic rock), or biological (e.g., cell, protein, neuron) system. As described in detail below, the quantum sensing system 100 is configured to determine at least one characteristic (e.g., spatial, temporal, and/or vectorial characteristic) of the electromagnetic signal generated by the electromagnetic signal-generating system 102.

The quantum sensing system 100 includes at least one quantum probe 110 that includes at least one qubit 114. For instance, the at least one quantum probe 110 may include a semiconductor, a solid-state host (e.g., diamond solid-state host), etc. The at least one qubit 114 may be any two-state quantum mechanical system. For example, the at least one qubit 114 may include electrons (e.g., electron spin qubits), photons (e.g., polarization encoding or time bin encoding qubits), atomic nuclei (e.g., nuclear spin encoded qubits), quantum dots, Josephson junction (e.g., flux qubits), or solid-state defects (e.g., nitrogen vacancy center defects, silicon vacancy defects, or tin vacancy defects in a diamond solid-state host). The quantum sensing system 100 includes a control system 104, which may be any component, or combination of components, configured to control one or more components of the quantum sensing system 100 discussed herein and/or determine at least one characteristic of the magnetic field component of the electromagnetic signal.

FIG. 1B is a functional block diagram of an exemplary embodiment of control system 104 of FIG. 1A. The functional blocks may be embodied in any combination of hardware and software. For example, the functional blocks may be performed by different software modules executing on the same computing system, by different software modules executing on multiple different computing systems, by multiple different hardware components, or any combination thereof. The control system 104 may include an electromagnetic field generator controller 150. The electromagnetic field generator controller 150 may control an electromagnetic field generator, such as electromagnetic field generator 106 of FIG. 1A, to apply at least one pulse sequence to at least one qubit, such as the at least one qubit 114 of FIG. 1. For instance, the electromagnetic field generator controller 150 may provide a time-ordered plurality of current (or voltage) pulses (e.g., the at least one pulse sequence) to the electromagnetic field generator, resulting in the electromagnetic field generator generating and applying at least one orthonormal electromagnetic field pulse sequence or at least one calibration electromagnetic field pulse sequence, in accordance with the at least one pulse sequence. The control system 104 may include a triggering interface 154. The triggering interface 154 may trigger an electromagnetic signal-generating system, such as electromagnetic signal-generating system 102 of FIG. 1A, to produce an electromagnetic signal. For instance, the triggering interface 154 may provide a command, trigger, instruction, etc., to the electromagnetic signal-generating system, and the electromagnetic signal-generating system may produce the electromagnetic signal in response to the command, trigger, instruction, etc. In some examples, the triggering interface 154 is configured to command, trigger, instruct, etc. the electromagnetic signal-generating system to produce the electromagnetic signal.

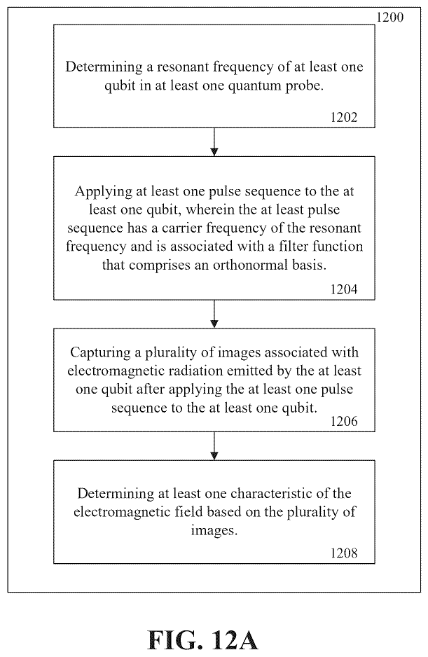

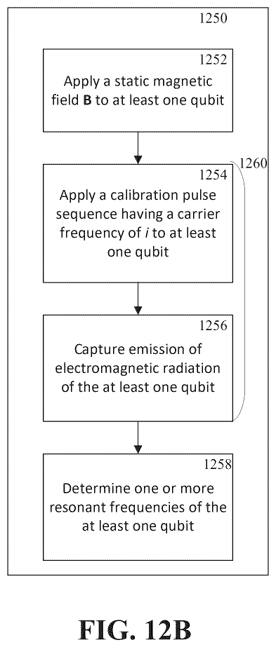

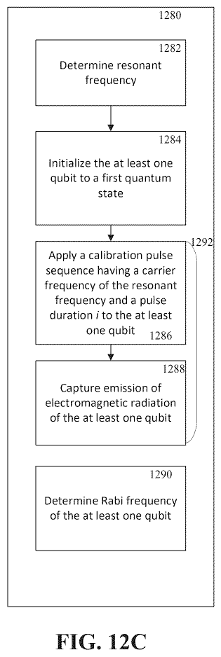

The control system 104 may include a laser controller 156. The laser controller 156 may trigger initialization of the at least one qubit to a first quantum state by triggering a laser, such as described herein, to illuminate the at least one qubit with light. For instance, the laser controller 156 may provide a command, instruction, trigger, etc. to the laser, and the laser may modulate the light (e.g., turn off/on) in response to the command, instruction, trigger, etc. The laser controller 156 may trigger emission of electromagnetic radiation from the at least one qubit with light by triggering a laser, such as described herein, to illuminate the at least one qubit with light. The control system 104 may include an analysis engine 152. The analysis engine 152 may receive, store, display, and/or process an image or a plurality of images captured via a camera system, such as camera system 112 of FIG. 1. In some examples, the analysis engine 152 may use the image, or the plurality of images, to determine at least one characteristic of the electromagnetic signal. For instance, based on the image, or the plurality of images, the analysis engine 152 may use a reconstruction equation, such as described herein, to reconstruct the magnetic field component of the electromagnetic signal. The analysis engine 152 may determine the at least one characteristic of the electromagnetic signal using the reconstructed magnetic field component of the electromagnetic signal. In some examples, the analysis engine 152 may receive, store, display, and/or process electromagnetic radiation emitted from the at least one qubit and captured by a photodetector in the camera system, such as described herein. The analysis engine 152 may use the measured emitted electromagnetic radiation to determine one or more resonant frequencies of the at least one qubit and/or a Rabi frequency of the at least one qubit, such as described in reference to FIGS. 12B and 12C, respectively.

Referring back to FIG. 1A, the quantum sensing system 100 may include an electromagnetic field generator 106 configured to apply at least one orthonormal electromagnetic field pulse sequence to the at least one qubit 114 of the at least one quantum probe 110. The electromagnetic field generator 106 may be configured to apply at least one calibration electromagnetic field pulse sequence to the at least one qubit 114. For instance, the at least one calibration electromagnetic field pulse sequence may be generated according to a CW-ODMR pulse sequence, a pulsed ODMR pulse sequence, or a Rabi pulse sequence, and the at least one calibration electromagnetic field pulse sequence may be used in a method to determine one or more resonant frequencies of the at least one qubit 114 or a method to determine a Rabi frequency of the at least one qubit 114. The control system 104 may control the electromagnetic field generator 106 to apply at least one pulse sequence 108 to the at least one qubit 114. For instance, the control system 104 may control the electromagnetic field generator 106 to generate an orthonormal electromagnetic field pulse sequence, which may be defined by the at least one pulse sequence 108. The control system 104 may control the electromagnetic field generator 106 to generate the at least one calibration electromagnetic field pulse sequence. The electromagnetic field generator 106 may be a printed circuit board (PCB), a field programmable gate array (FPGA), a wire loop, etc. The control system 104 may provide a time-ordered plurality of current (or voltage) pulses to the electromagnetic field generator 106, resulting in the electromagnetic field generator generating the at least one orthonormal electromagnetic field pulse sequence or the at least one calibration electromagnetic field pulse sequence.

The time-ordered plurality of current (or voltage) pulses generating the at least one orthonormal electromagnetic field pulse sequence may be defined by at least one pulse sequence 108. As such, applying the at least one orthonormal electromagnetic field pulse sequence generated according to the at least one pulse sequence 108 may constitute applying the at least one pulse sequence 108 to the at least one qubit 114 of the at least one quantum probe 110. The at least one pulse sequence 108 may be generated by the control system 104 according to a filter function of a basis that is orthonormal in time (or frequency). For instance, the least one pulse sequence 108 may be generated according to a Walsh basis that includes Walsh functions (e.g., filter functions). Specifically, the Walsh function is defined by one or more piecewise digital square pulses of value ±1, and a complete set of the Walsh functions forms the Walsh basis of order N, which may be represented as {w_{N}(t)}. One or more pulses associated with the Walsh function and included in the at least one pulse sequence 108 may have a carrier frequency, shape, duration, phase, amplitude, etc. The at least one pulse sequence 108 may be defined by one or more additional pulses (e.g., pulses), and each one or more additional pulses may have a carrier frequency, shape, duration, amplitude, phase, etc. For instance, the carrier frequency may be a microwave frequency, such that the at least one pulse sequence 108 may be a microwave pulse sequence (e.g., a pulse sequence having a plurality of pulses with a microwave frequency as the carrier frequency).

The carrier frequency of the one or more pulses of the least one pulse sequence 108 may be associated with one or more resonant frequencies of the at least one qubit 114. The resonant frequency may be an energy difference between the first quantum state and a higher energy quantum state. A value of the higher energy quantum state, and thus the resonant frequency, may be associated with one or more crystallographic orientations of the at least one qubit 114 of the at least one quantum probe 110. As such, applying the at least one orthonormal electromagnetic field pulse sequence generated according to the at least one pulse sequence 108 having a carrier frequency of the resonant frequency may switch the at least one qubit 114 from the first quantum state to the higher-energy quantum state. Applying the at least one orthonormal electromagnetic field pulse sequence generated according to the at least one pulse sequence 108 having a carrier frequency of the resonant frequency may cause the at least one qubit 114 to accumulate phase representing the projection of the electromagnetic signal onto the filter function (e.g., phase measurement associated with coefficients of the filter function). As such, the quantum sensing system 100 may be configured to determine, receive, or otherwise obtain one or more resonant frequencies of the at least one qubit 114 and/or a Rabi frequency of the at least one qubit 114.

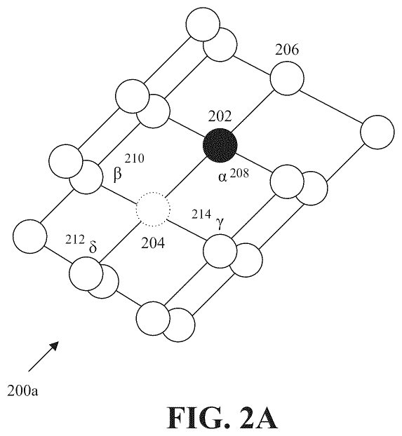

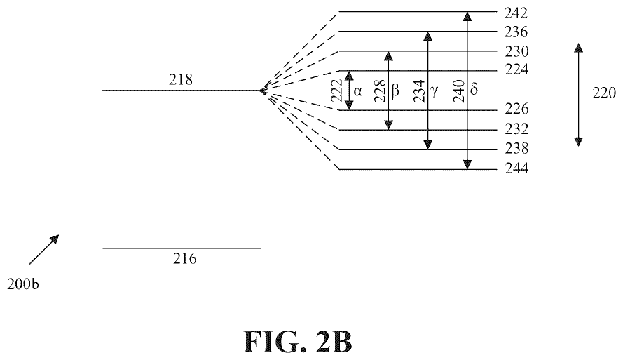

FIGS. 2A and 2B illustrate aspects of an example of the at least one quantum probe that are relevant to determining one or more resonant frequencies associated with the at least one crystallographic orientation of at least one qubit (e.g., at least one nitrogen vacancy center defect) of the at least one quantum probe (e.g., diamond solid-state host).

FIG. 2A illustrates the crystallographic orientations of the nitrogen vacancy center defect 200a, and the nitrogen vacancy center defect 200a is an exemplary embodiment of the at least one qubit 114 of FIG. 1A. The nitrogen vacancy center defect 200a includes a nitrogen atom 202 adjacent to an atomic vacancy 204 in a diamond's carbon lattice structure 206. The diamond's carbon lattice structure 206 is an exemplary embodiment of the at least one quantum probe 110 of FIG. 1A. The nitrogen atom 202 may be implanted, artificially grown, or naturally occurring in the carbon lattice structure 206, and the atomic vacancy 204 may be produced by irradiation of the carbon lattice structure 206 (e.g., diamond) with high-energy particles, such as electrons, protons, neutrons, ions, or gamma photons. The irradiation of the carbon lattice structure 206 may be followed by an anneal. The nitrogen vacancy center defect 200a may have crystallographic orientations in the diamond's carbon lattice structure 206. For instance, the nitrogen vacancy center defect 200a may have an α crystallographic orientation 208, a β crystallographic orientation 210, a δ crystallographic orientation 212, or a γ crystallographic orientation 214.

FIG. 2B illustrates the ground energy structure 200b of the nitrogen vacancy center defect 200a of FIG. 2A, according to some examples. The nitrogen vacancy center defect 200a may have a first quantum state 216 (e.g., |ms=0 [symbol] ) and may have a second quantum state 218, which may be degenerate states (e.g., |ms=±1 [symbol] ). Under a static magnetic field B 220 (e.g., B=(Bₓ, B_{y}, B_{z})), the |ms=±1) may split (e.g., become non-degenerate) with magnitudes associated with the magnitude and direction of the static magnetic field B 220 and the crystallographic orientation of the nitrogen vacancy center defect 200a. For instance, depending on the static magnetic field B 220, the |ms=±1 [symbol] of a nitrogen vacancy defect 200a with an α crystallographic orientation (208 in FIG. 2A) may split into a higher energy state 224 (e.g., |ms=±1 [symbol] ) and a lower energy state 226 (e.g., |ms=−1 [symbol] ), such that the energy difference between 224 and 226 may be 222. For a nitrogen vacancy center defect 200a with a β crystallographic orientation (210 in FIG. 2A), the |ms=±1) may similarly split into a higher energy state 230 and a lower energy state 232 with an energy difference of 228, depending on the static magnetic field B 220. For a nitrogen vacancy center defect 200a with a γ crystallographic orientation (214 in FIG. 2A), the |ms=±1 [symbol] may split into a higher energy state 236 and a lower energy state 238 with an energy difference 234, depending on the static magnetic field B 220. For a nitrogen vacancy center defect with a δ crystallographic orientation (212 in FIG. 2A), the |ms=±1 [symbol] may split into a higher energy state 242 and a lower energy state 244 with an energy difference 244, depending on the static magnetic field B 220. As such, the resonant frequency may be associated with the crystallographic orientation of the nitrogen vacancy center defect 200a. For instance, the resonant frequency for a nitrogen vacancy center defect 200a with the α crystallographic orientation (208 in FIG. 2A) may be the energy difference between the 216 state and the 224 state (or 226). The resonant frequency for a nitrogen vacancy center defect 200a with the β crystallographic orientation (210 in FIG. 2A) may be the energy difference between the 216 state and the 230 state (or 232). The resonant frequency for a nitrogen vacancy center defect 200a with the γ crystallographic orientation (214 in FIG. 2A) may be the energy difference between the 216 state and the 236 state (or 238). For a nitrogen vacancy center defect 200a with the δ crystallographic orientation (212 in FIG. 2A), the resonant frequency may be the energy difference between the 216 state and the 242 state (or 244). In some examples, as in FIG. 2B, the crystallographic orientation with the largest energy difference is the δ, followed by the γ, followed by the β, and followed by the α. However, a person of skill in the art will appreciate that the energy differences may have any magnitude and may be in any order (e.g., γ, β, α, δ). As such, determining the one or more resonant frequencies of the at least one qubit 114 of FIG. 1A may be relevant for generating the at least one pulse sequence 108 having one or more carrier frequencies of the one or more quantum state frequencies.

Referring to FIG. 1A, the orthonormal electromagnetic field pulse sequence resulting from the at least one pulse sequence 108 to the at least one quantum probe 110 induces the at least one qubit 114 to accumulate a phase. The accumulated phase may be associated with the orthonormal electromagnetic field pulse sequence and an electromagnetic signal produced by the electromagnetic signal-generating system 102.

The electromagnetic signal-generating system 102 may be separate from the quantum sensing system 100. In some examples, the electromagnetic signal is included in the quantum sensing system 100. In some examples, the control system 104 is configured to provide a command, trigger, instruction, etc., to the electromagnetic signal-generating system 102. For instance, the control system 104 may output a trigger signal 114 to the electromagnetic signal-generating system 102. The electromagnetic signal-generating system 102 may produce the electromagnetic signal in response to the command, trigger, instruction, etc. (e.g., in response to the trigger signal 114). For instance, the electromagnetic signal-generating system 102 may be a microelectronic system (e.g., including an integrated circuit). The control system 104 may provide a command, trigger, instruction, etc. to the electromagnetic signal-generating system 102 (e.g., may output the trigger signal 114). The electromagnetic signal-generating system 102 may apply a current (or voltage) to the microelectronics system to produce an electromagnetic signal in response to the command, trigger, instruction, etc. from the control system 104 (e.g., in response to the trigger signal 114 from the control system 104). In some examples, the control system 104 is configured to command, trigger, instruct, etc. the electromagnetic signal-generating system 102 to produce the electromagnetic signal. For instance, the electromagnetic signal-generating system 102 may be the microelectronics system, and the electromagnetic signal of the microelectronics system may be produced when the control system 104 applies a current (or voltage) to the microelectronics system.

Another example of the electromagnetic signal-generating system 102 may be an in vitro mouse brain with connected electrodes. In some examples, the control system 104 provides a command, trigger, instruction, etc. (e.g., the trigger signal 114) to the electromagnetic signal-generating system 102. The electromagnetic signal-generating system 102 then may apply a current (or voltage) to the connected electrodes to produce an electromagnetic signal in response to the command, trigger, instruction, etc. (e.g., the trigger signal 114) from the control system 104. In some examples, the electromagnetic signal of the in vitro mouse's brain is produced when the control system 104 applies a current (or voltage) to the connected electrodes. In any electromagnetic signal-generating system 102 described herein, the electromagnetic signal may have the form b(r,t)=(bₓ(r,t), b_{y}(r,t), b_{z}(r,t)), where r=(x,y,z). In some examples, the electromagnetic signal is produced by the electromagnetic signal-generating system 102 in correspondence with the application of the at least one orthonormal electromagnetic field pulse sequence. The electromagnetic signal may be produced for each application of the at least one orthonormal electromagnetic field pulse sequence, such that at least one characteristic of the electromagnetic signal is consistent for each application of the at least one orthonormal electromagnetic field pulse sequence. For instance, the control system 104 may provide a command, trigger, instruction, etc., to the electromagnetic signal-generating system 102 in correspondence with each application of the at least one orthonormal electromagnetic field pulse sequence to the at least one qubit 114. In response to the command, trigger, instruction, etc. from the control system 104, the electromagnetic signal-generating system 102 may produce the electromagnetic signal for each application of the at least one orthonormal electromagnetic field pulse sequence. As such, the electromagnetic signal has at least one characteristic consistent for all applications of the orthonormal electromagnetic field pulse sequence to the at least one qubit 114. The at least one characteristic of the electromagnetic signal that is consistent may be an amplitude characteristic, such that the electromagnetic signal is produced with a consistent amplitude in correspondence with each application of the orthonormal electromagnetic field pulse sequence. The at least one characteristic of the electromagnetic signal that is consistent may be a phase characteristic, such that the electromagnetic signal is produced with a consistent phase in correspondence with each application of the orthonormal electromagnetic field pulse sequence.

In some examples, the at least one orthonormal electromagnetic field pulse sequence may create a superposition of multiple quantum states of the at least one qubit 114, induce the at least one qubit 114 to accumulate a phase representing the projection of the electromagnetic signal along the filter function inherent to the at least one orthonormal electromagnetic field pulse sequence, and then collapse the superposition of multiple quantum states so that the accumulated phase may be measured (e.g., phase measurement associated with coefficients of the filter function). The control system 104 may trigger emission of electromagnetic radiation from the at least one qubit 114 by illuminating the at least one qubit 114 with light. The emitted electromagnetic radiation represents the accumulated phase.

The emitted electromagnetic radiation from the at least one qubit 114 may be captured via a camera system 112. The camera system 112 may capture a plurality of images of the emitted electromagnetic radiation. The control system 104 may control various aspects of the image capture by the camera system 112. For instance, the control system 104 may control a duration to capture the plurality of images (e.g., capture duration), when the plurality of images may be captured, a phase associated with the plurality of images, or any other image capture characteristic. The control system 104 may also be configured to display, receive, store, and/or process the plurality of images captured via the camera system 112. For instance, the control system 104 may linearly combine (e.g., average) a plurality of images to form at least one combined image. The control system 104 may make a video from the plurality of images or a plurality of the combined images, and the video may display the temporal, spatial, and/or vectorial evolution of the electromagnetic signal of the electromagnetic signal-generating system 102.

The control system 104 is configured to determine at least one characteristic of the electromagnetic signal of the electromagnetic signal-generating system 102 based on the images captured by the camera system 112. The control system 104 may reconstruct the magnetic field component of the electromagnetic signal using a reconstruction equation. The control system 104 may determine the at least one characteristic of the electromagnetic signal using the reconstructed magnetic field component of the electromagnetic signal. In some examples, the control system 104 determines all characteristics of the electromagnetic signal using the reconstructed magnetic field component of the electromagnetic signal (e.g., spatial, temporal, and vectorial characteristics). The reconstruction equation approximates the magnetic field component of the electromagnetic signal using the emitted electromagnetic radiation captured by the images and the filter functions inherent to the orthonormal electromagnetic field pulse sequences. The reconstruction equation may be specific to the type of the at least one quantum probe 110. For example, the reconstruction equation may have a different form depending upon the two-state quantum mechanical system (e.g., the at least one qubit 114) of the at least one quantum probe 110. For instance, when the at least one qubit 114 is a nitrogen vacancy center defect, the reconstruction equation has the following form:

$$\text{?} ( r , t ) = {Σ}_{α} 〈 {b}_{s e n s e}^{k} ( r , t ) , {κ}_{α} ( t ) 〉 {κ}_{α} ( t ) , \qquad Equation 1$$

where [symbol] (r,t) is an approximation of the magnetic field component of the electromagnetic signal of the electromagnetic signal-generating system 102, with

$${b}_{s e n s e}^{k} ( r , t ) = ( {b}_{x , s e n s e} ( r , t ) , {b}_{y , s e n s e} ( r , t ) , {b}_{z s e n s e} ( r , t ) ) and \text{?} ( r , t ) = ( \text{?} ( r , t ) , \text{?} ( r , t ) , \text{?} ( r , t ) ) ,$$

where r=(x,y,z). In Equation 1, k is the crystallographic orientation of the at least one nitrogen vacancy center defect (e.g., at least one qubit 114) in a diamond solid-state host (e.g., quantum probe 110), a is an element in the basis that is orthonormal in time (or frequency), and κₐ(t) is the filter function from the basis that is orthonormal in time (or frequency). In Equation 1,

$$〈 {b}_{s e n s e}^{k} ( r , t ) ,$$

κₐ(t) [symbol] die the coefficients spanning the basis that is orthonormal in time (or frequency), which are derived using the emitted electromagnetic radiation of the at least one nitrogen vacancy center defect captured by the images (e.g., phase measurements associated with the coefficients of the filter functions). The equation to derive the coefficients spanning the basis that is orthonormal in time (or frequency) based on the emitted electromagnetic radiation (e.g., phase accumulated of the at least one nitrogen vacancy center defect) has the following form:

$${ϕ}_{α , k} ( T ) = {\int }_{0}^{T} d t {κ}_{α} ( t ) {b}_{s e n s e}^{k} ( r , t ) = T 〈 {b}_{s e n s e}^{k} ( r , t ) , {κ}_{α} ( t ) 〉 . \qquad Equation 2$$

Equation 1 may be derived using the Hamiltonian of the at least one qubit. The Hamiltonian for the nitrogen vacancy center defect has the following form:

$$H = D {S}_{Z}^{2} + {\sum }_{k ∈ J} [ \frac{{w}_{0}^{k}}{2} + γ {b}_{s e n s e}^{k} ( r , t ) {S}_{z}^{k} + {f}_{k} ( t ) {S}_{x}^{k} ] , \qquad Equation 3$$

where

$${w}_{0}^{k}$$

is a resonant frequency of the at least one nitrogen vacancy center defect in the k crystallographic orientation, γ is the gyromagnetic ratio of the at least one nitrogen vacancy center defect, and fₖ(t) is the at least one pulse sequence (e.g., pulse sequence 108 of FIG. 1A) with a carrier frequency of the resonant frequency of the at least one nitrogen vacancy center defect in the k crystallographic direction. Additionally, D is the fine structure term (e.g., zero-field splitting, such as described in reference to FIG. 12B) and

$${S}_{z}^{k} and {S}_{x}^{k}$$

are the electron spin operators.

The form of the reconstruction equation (Equation 1) may also be associated with the basis that is orthonormal in time (or frequency). For instance, in the Walsh basis, and when the at least one qubit 114 is a nitrogen vacancy center defect, the reconstruction equation may have the following form:

$$\text{?} ( r , t ) = {Σ}_{m = 0}^{N} {w}_{m} ( t / T ) 〈 {b}_{s e n s e}^{k} ( r , t / T ) , {w}_{m} ( t / T ) 〉 , \qquad Equation 4$$

where

$$\text{?} ( r , t )$$

is an approximation of the magnetic field component of the electromagnetic signal of the electromagnetic signal-generating system 102 with

$$\text{?} ( r , t ) = ( \text{?} ( r , t ) , \text{?} ( r , t ) , \text{?} ( r , t ) ) and {b}_{sense}^{k} ( r , t ) = ( {b}_{x , sense} ( r , t ) , {b}_{y , sense} ( r , t ) , {b}_{z , sense} ( r , t ) ) ,$$

where r=(x,y,z). In Equation 4, m is an element in the Walsh basis (e.g., Walsh order), N may be the largest element in the Walsh basis (e.g., N may be a value greater than m, but N may not be the maximum element in the Walsh basis), wₘ(t/T) is a Walsh function with the Walsh order m, and T is the duration of the at least one pulse sequence 108 (e.g., duration of the at least one orthonormal electromagnetic field pulse sequence) and the duration of the electromagnetic signal. In Equation 4,

$$〈 {b}_{s e n s e}^{k} ( r , t / T ) ,$$

wₘ(t/T) [symbol] are the coefficients spanning the Walsh basis, which are derived using the emitted electromagnetic radiation of the at least one nitrogen vacancy center defect captured by the images (e.g., using Equation 2). Similarly, Equation 4 may be derived using the Hamiltonian of the at least one nitrogen vacancy center defect (e.g., using Equation 3). As such, with a basis that is orthonormal in time (or frequency), a filter function from the basis that is orthonormal in time (or frequency), and coefficients spanning the basis that is orthonormal in time (or frequency) (e.g., captured emitted electromagnetic radiation), a reconstruction equation (e.g., Equation 1 or Equation 4) may be used to approximate the magnetic field component of an electromagnetic signal. At least one characteristic of the electromagnetic signal may be determined from the approximated magnetic field component of the electromagnetic signal.

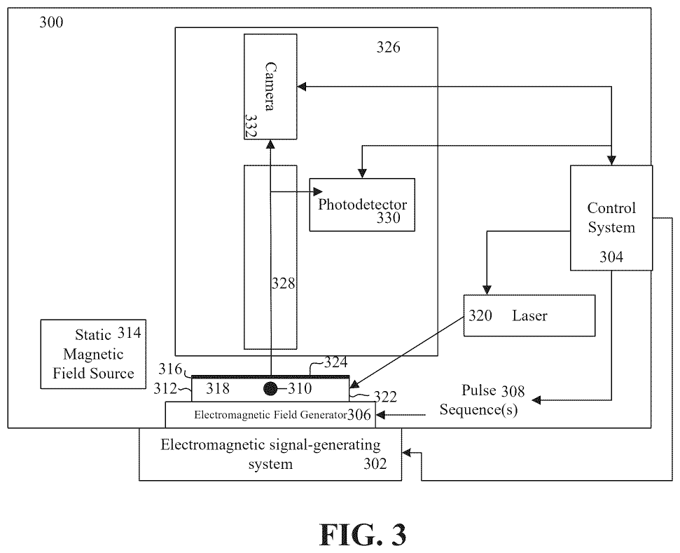

FIG. 3 illustrates an exemplary embodiment of quantum sensing system 100 of FIG. 1A. Quantum sensing system 300 utilizes at least one nitrogen vacancy center defect 310 as the at least one qubit 114 of FIG. 1A and utilizes orthonormal electromagnetic field pulse sequences generated according to a Walsh basis. As such, applying the orthonormal electromagnetic field pulse sequences generated according to the Walsh basis causes the at least one nitrogen vacancy center 310 to accumulate phase representing a projection of an electromagnetic signal onto a Walsh function (e.g., phase measurement associated with coefficients of the Walsh function). The emitted electromagnetic radiation associated with the accumulated phase is measured with a camera system 326, which is an exemplary embodiment of camera system 112 of FIG. 1A. The quantum sensing system 300 includes a control system 304, which is an exemplary embodiment of control system 104 of FIG. 1A. The control system 304 may use the emitted electromagnetic radiation captured via a plurality of images to approximate the magnetic field component of the electromagnetic signal with Equation 4.

Quantum sensing system 300 includes at least one nitrogen vacancy center defect 310 in a diamond solid-state host 312. However, a person of skill in the art will appreciate that any two-state quantum mechanical system (e.g., any qubit) and any quantum probe described herein may be used instead of the at least one nitrogen vacancy center defect 310 and the diamond solid-state host 312, respectively. In some examples, the at least one nitrogen vacancy center defect 310 is located within a layer 316 on the diamond solid state host 312. The layer 316 may have a thickness in a range of about 1 μm to 50 μm, for example 1 μm, 2 μm, 5 μm, 10 μm, 20 μm, 30 μm, 40 μm, or 50 μm. In some examples, the layer 316 has a thickness greater than or equal to 1 μm, 2 μm, 5 μm, 10 μm, 20 μm, 30 μm, 40 μm, or 50 μm. In some examples, the layer 316 has a thickness less than or equal to 1 μm, 2 μm, 5 μm, 10 μm, 20 μm, 30 μm, 40 μm, or 50 μm. In some examples, the at least one nitrogen vacancy center defect 310 is located within a body 318 of the diamond solid-state host 312. The at least one nitrogen vacancy center defect 310 may have α crystallographic orientation in the diamond solid-state host 312 (e.g., α, β, γ, δ as described in reference to FIGS. 2A and 2B). The degenerate |ms=±1 [symbol] states of the at least one nitrogen vacancy center 310 may be split via a static magnetic field B (e.g., static magnetic field B as described in reference to FIG. 2B) applied by a static magnetic field source 314. The static magnetic field source 314 may be any source configured to produce and apply the static magnetic field B, such as one or more ring magnets, one or more bar magnets, or one or more coils. The static magnetic field B may be in a range of about 0.2 mT to 4.0 mT, for instance 0.2 mT, 0.4 mT, 0.6 mT, 0.8 mT, 1.0 mT, 1.2 mT, 1.4 mT, 1.6 mT, 1.8 mT, 2.0 mT, 2.2 mT, 2.4 mT, 2.6 mT, 2.8 mT, 3.0 mT, 3.2 mT, 3.4 mT, 3.6 mT, 3.8 mT, or 4.0 mT. The static magnetic field B may be greater than or equal to 0.2 mT, 0.4 mT, 0.6 mT, 0.8 mT, 1.0 mT, 1.2 mT, 1.4 mT, 1.6 mT, 1.8 mT, 2.0 mT, 2.2 mT, 2.4 mT, 2.6 mT, 2.8 mT, 3.0 mT, 3.2 mT, 3.4 mT, 3.6 mT, 3.8 mT, or 4.0 mT. The static magnetic field B may be less than or equal to 0.2 mT, 0.4 mT, 0.6 mT, 0.8 mT, 1.0 mT, 1.2 mT, 1.4 mT, 1.6 mT, 1.8 mT, 2.0 mT, 2.2 mT, 2.4 mT, 2.6 mT, 2.8 mT, 3.0 mT, 3.2 mT, 3.4 mT, 3.6 mT, 3.8 mT, or 4.0 mT.

The quantum sensing system 300 may also include an electromagnetic field generator 306, which is an exemplary embodiment of electromagnetic field generator 106 of FIG. 1A. The electromagnetic field generator 306 may be configured to apply at least one orthonormal electromagnetic field pulse sequence to the at least one nitrogen vacancy center defect 310 of the diamond solid-state host 312. The electromagnetic field generator 306 may be configured to apply at least one calibration electromagnetic field pulse sequence to the at least one nitrogen vacancy center 310 to determine the one or more quantum state frequencies of the at least one nitrogen vacancy center defect 310 or a Rabi frequency of the at least one nitrogen vacancy center defect 310, such as described in method 1250 of FIG. 12B and method 1280 of FIG. 12C, respectively. The control system 304 controls the electromagnetic field generator 306 apply at least one pulse sequence 308 to the at least one nitrogen vacancy center defect 310. For instance, the control system 304 may control the electromagnetic field generator 306 to generate an orthonormal electromagnetic field pulse sequence, which may be defined by the at least one pulse sequence 308. The control system 304 may control the electromagnetic field generator 306 to generate the at least one calibration electromagnetic field pulse sequence.

The at least one orthonormal electromagnetic field pulse sequence may be generated according to the at least one pulse sequence 308. The at least one pulse sequence 308 may be generated by the control system 304. The at least one pulse sequence 308 may be a Walsh pulse sequence, such that the Walsh pulse sequence includes one or more pulses associated with a Walsh function. The Walsh function may be a filter function of the Walsh basis, which may be an exemplary embodiment of a basis that is orthonormal in time (or frequency)). The at least one pulse sequence 308 may also include pulses (e.g., π/2-pulses) that may not associated with the Walsh function. The plurality of pulses of the at least one pulse sequence 308 may be associated with an amplitude, phase, frequency (e.g., carrier frequency), duration, shape, etc.

The carrier frequency of the plurality of pulses of the least one pulse sequence 308 may be associated with one or more resonant frequencies of the at least one nitrogen vacancy center defect 310. The one or more resonant frequencies of the at least one nitrogen vacancy center defect 310 may be any resonant frequency described herein, for example as described in reference to FIGS. 1, 2A, and 2B. As such, applying the at least one orthonormal electromagnetic field pulse sequence generated according to the at least one pulse sequence 308 may switch the at least one nitrogen vacancy center defect 310 from the first quantum state to the higher-energy quantum state. Applying the at least one orthonormal electromagnetic field pulse sequence may cause the at least one nitrogen vacancy center defect 310 to accumulate phase representing the projection of an electromagnetic signal onto the Walsh function (e.g., phase measurement associated with coefficients of the Walsh function). The electromagnetic signal may be produced by an electromagnetic signal-generating system 302, which is an exemplary embodiment of electromagnetic signal-generating system 102 of FIG. 1A. As such, determining the one or more resonant frequencies of the at least one nitrogen vacancy center defect 310 may be relevant for the quantum sensing system 300. As such, the quantum sensing system 300 may be configured to determine, receive, or otherwise obtain the one or more quantum state frequencies of the at least one nitrogen vacancy center defect 310, for instance by using method 1250 of FIG. 12B.

In some examples, the electromagnetic field generator 306 may be positioned on an electromagnetic signal-generating system 302, which is an exemplary embodiment of electromagnetic signal-generating system 102 of FIG. 1A. The at least one nitrogen vacancy center defect 310 in the diamond solid-state host 314 may then be positioned on the electromagnetic field generator 306. In other examples, the at least one nitrogen vacancy center defect 310 in the diamond solid-state host 314 may be positioned on the electromagnetic signal-generating system 302 and the electromagnetic field generator 306 may be positioned on the at least one nitrogen vacancy center 310 in the diamond solid-state host 314. In some examples, the distance between the electromagnetic signal-generating system 302 and the diamond solid-state host 314 is associated with the thickness of the layer 316.

The quantum sensing system 300 may include a laser 320. The control system 304 may control the laser 320. For instance, the control system 304 may provide an instruction, command, trigger, etc. to the laser 320, and the laser 320 may modulate laser light (e.g., turn the laser 320 on or off) in response to receiving the instruction, command, trigger, etc. In some examples, the laser 320 may be a part of the control system 304. The laser light from the laser 320 may be directed onto the diamond solid-state host 312, for example onto a side 322 of the diamond solid-state host 312 (e.g., side-illumination) or onto a top surface 324 of the diamond solid-state host 312. In some examples, the side-illumination induces total internal reflection (TIR) of the laser light in the body 318 of the diamond solid-state host 312. In some examples, the laser light from the laser 320 is manipulated by and directed onto the diamond solid-state host 312 using various optical components (e.g., attenuator(s), filter(s), lens(es), mirror(s) etc.). The various optical components may manipulate the laser light from the laser 320 prior to directing it onto the diamond solid-state host 312. The laser 320 may be used to initialize the at least one nitrogen vacancy center defect 310 to a first quantum state, such as the 216 state (e.g., |ms=0 [symbol] ) of FIG. 2B. The laser 320 may also trigger emission of electromagnetic radiation from the at least one nitrogen vacancy center defect 310 by illuminating the diamond solid-state host 312 with the laser light. The emitted electromagnetic radiation from the at least one nitrogen vacancy center defect 310 (e.g., red light emitted from the at least one nitrogen vacancy center defect 310) may represent the response of the at least one nitrogen vacancy center defect 310 to the at least one pulse sequence 308, while the at least one nitrogen vacancy center defect 310 may be exposed to the electromagnetic signal of the electromagnetic signal-generating system 302 (e.g., accumulated phase of the at least one nitrogen vacancy center 310).

The emitted electromagnetic radiation from the at least one nitrogen vacancy center defect 310 (e.g., red light emitted from the at least one nitrogen vacancy center defect 310) may be captured via a camera system 326. The camera system 326 may include a plurality of optical components 328 (e.g., attenuator(s), objective(s), filter(s), lens(es), etc.) that may direct the emitted electromagnetic radiation to a photodetector 330 and/or a camera 332. The photodetector 330 may be a photodiode, a Si amplified photodetector, a Ge amplified photodetector, a InGaAs amplified photodetector, a InAsSb amplified photodetector, or any other photodetector that can measure, record, or capture the emitted electromagnetic radiation. In some examples, the photodetector 330 may be used to capture a magnitude of the emitted electromagnetic radiation. For instance, the photodetector 330 may be used to capture the emitted electromagnetic radiation of a step 1256 in method 1250 of FIG. 12B or a step 1288 in method 1280 of FIG. 12C. The camera 332 may be any BASLER camera, any lock-in camera, for instance a HELICAM, or any other camera that may capture, measure, or record the emitted electromagnetic radiation as an image or a plurality of images. The image or each image in the plurality of images may be formed from a plurality of pixels on the camera 332, such that each pixel in the plurality of pixels may capture the emitted electromagnetic radiation.

The camera 332 and the photodetector 330 may be separately, or simultaneously, controlled via the control system 304. For instance, the control system 304 may control a duration to capture the emitted electromagnetic radiation or when the emitted electromagnetic radiation may be captured. The control system may also control a phase associated with the image or plurality of images captured via the camera 332 if the camera 332 a lock-in camera, such as a HELICAM. The control system 304 may receive, store, and/or process the image or plurality of images captured by the camera 332. For instance, the control system 304 may linearly combine (e.g., average) the plurality of images to form at least one final image. The control system 304 may also make a video from the plurality of images, and the video may display the temporal, spatial, and/or vectorial evolution of the electromagnetic signal of the electromagnetic signal-generating system 302. The control system 304 may also receive, store, and/or process any emitted electromagnetic radiation measured via the photodetector 330. For instance, the control system 304 may process the emitted electromagnetic radiation measured via the photodetector 330 to determine the resonant frequency of the at least one nitrogen vacancy center defect 310, such as described in a step 1258 in method 1250 of FIG. 12B, or the Rabi frequency of the at least one nitrogen vacancy center defect 310, such as described in step 1290 of FIG. 12C. Based on the image or the plurality of images measured via the camera 332 and/or the emitted electromagnetic radiation measured via the photodetector 330, at least one characteristic of the electromagnetic signal of the electromagnetic signal-generating system 302 may be determined. For instance, the control system 304 may extract the coefficients

$$〈 {b}_{s e n s e}^{k} ( r , t / T ) ,$$

wₘ(t/T [symbol] ) spanning the Walsh basis using the emitted electromagnetic radiation, which may be in the image or the plurality of images. With the coefficients extracted, the reconstruction equation (Equation 4) may be used by the control system 304 to approximate the magnetic field component of the electromagnetic signal. From the approximated magnetic field component of the electromagnetic signal, at least one characteristic of the electromagnetic signal of the electromagnetic signal-generating system 302 may be determined using the control system 304. In some examples, the approximation of the magnetic field component of the electromagnetic signal via the reconstruction equation (Equation 1 or Equation 4) may be associated with an approximation, or reconstruction, error. As such, the at least one characteristic of the electromagnetic signal determined via the approximated magnetic field component of the electromagnetic signal may also be associated with the approximation, or reconstruction error.

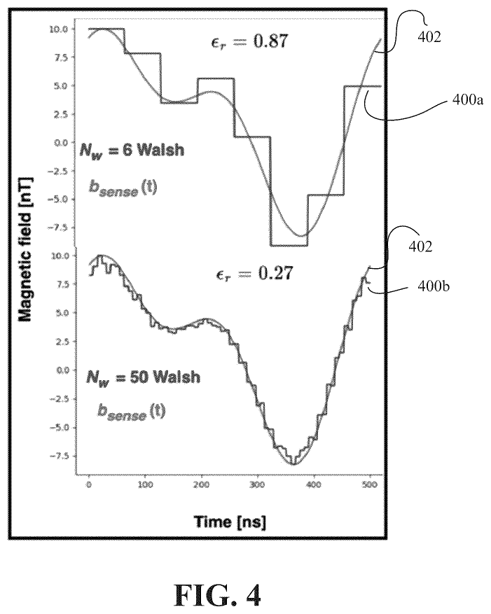

In some examples, the control system 304 may approximate the magnetic field component of the electromagnetic signal via the reconstruction equation (Equation 4) at each pixel in the plurality of pixels that form the image or the plurality of images captured by the camera 332. FIG. 4 illustrates an approximation of the magnetic field component of an electromagnetic signal, bₛₑₙₛₑ(t), at a single pixel in a plurality of pixels that may form an image or a plurality of images captured by a camera system (e.g., camera system 326 of FIG. 3), according to some examples. Although the electromagnetic signal may be produced by an electromagnetic signal-generating system, such as electromagnetic signal-generating system 302 of FIG. 3, for illustration purposes, the electromagnetic signal bₛₑₙₛₑ(t) of FIG. 4 is represented by a well-defined function. The electromagnetic signal illustrated as 402 in FIG. 4 is

$${b}_{s e n s e} ( t ) = {b}_{0} ( 2 + 3 cos ( 2 π \frac{t}{T} ) ) + 3 cos ( 2 π \frac{t}{T} ) + 4 cos ( 4 π \frac{t}{T} ) + 6 cos ( 2 π \frac{t}{T} ) T ,$$

where T is a duration of at least one pulse sequence, such as the at least one pulse sequence 308 of FIG. 3. The magnetic field component of the electromagnetic signal may be approximated via the reconstruction equation (Equation 4), and the approximation is plotted as 400a and 400b.

FIG. 4 illustrates a first approximation 400a and a second approximation 400b. While both approximations utilize the reconstruction equation (Equation 4) to approximate the magnetic field component of the electromagnetic signal, the first approximation 400a has a maximum Walsh order of N=6 and the second approximation 400b has a maximum Walsh order of N=50. The first approximation 400a yields a reconstruction error, ϵᵣ, of 0.87, while the second approximation 400b yields a reconstruction error, ϵᵣ, of 0.27. The reconstruction errors of the first 400a and second 400b approximations demonstrate that the reconstruction error of the approximation decrease as the Walsh order increases. The reconstruction error is directly proportional to the Walsh order because the reconstruction equation (Equation 4) is a summation over the Walsh functions and coefficients spanning the Walsh basis. Thus, the more terms (e.g., Walsh functions and coefficients) to sum (e.g., the higher the Walsh order), the more accurate the approximation (e.g., the smaller the approximation error).

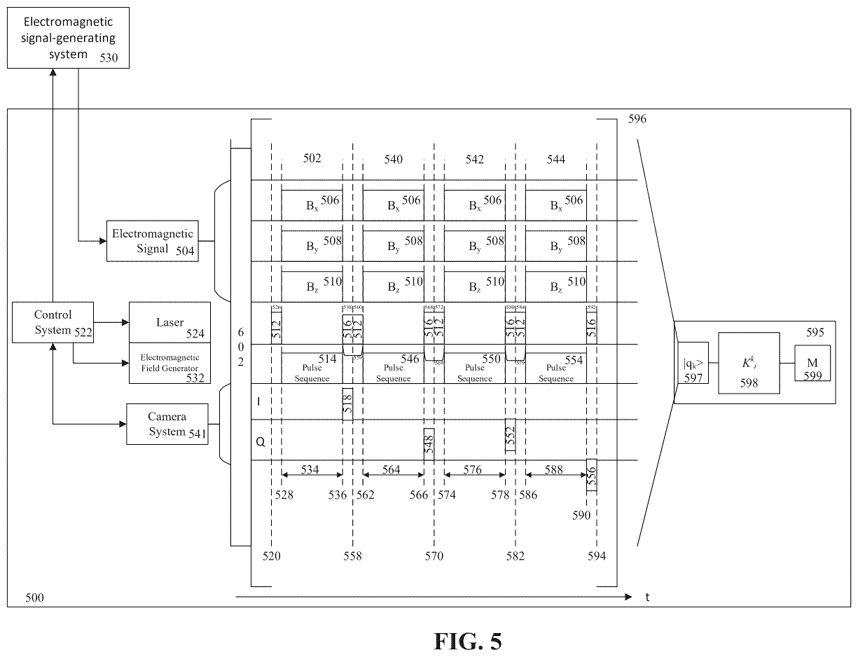

The determination of at least one characteristic of the electromagnetic signal using the quantum sensing system 300 of FIG. 3 or the quantum sensing system 100 of FIG. 1A may rely on precise synchronization and control of the various aforementioned systems. For example, in the quantum sensing system 300 of FIG. 3, a timing of the at least one pulse sequence 308 may correspond to a timing of laser light from laser 320. FIG. 5 illustrates the precise synchronization and control of the various systems in a quantum sensing system, such as quantum sensing system 300 of FIG. 3 or quantum sensing system 100 of FIG. 1A. Herein, the precise synchronization and control of the various systems in a quantum sensing system may be referred to as a quantum sensing process.

A quantum sensing process 500 may include a sensing block 502, and the sensing block 502 may include an electromagnetic signal 504 with a Bₓ component 506, a B_{y} component 508, and/or a B_{z} component 510, a first laser pulse 512, a pulse sequence 514, a second laser pulse 516, and an image capture 518. At a time 520, a control system 522, which may be any control system described herein, may command, instruct, trigger, etc. a laser 524 to turn on (e.g., illuminate a diamond solid-state host as described in reference to FIG. 3). The laser 524 is an exemplary embodiment of laser 320 of FIG. 3. After a duration 526 (e.g., at a time 528), the control system 522 may command, instruct, trigger, etc. the laser 524 to turn off. This modulation of the laser 524 via the control system 522 may be encapsulated in the first laser pulse 512, and the first laser pulse 512 may initialize at least one qubit (e.g., the at least one nitrogen vacancy center defect) to a first quantum state, as described herein. The at least one qubit may be any qubit described herein, for instance the at least one qubit 114 of FIG. 1A.

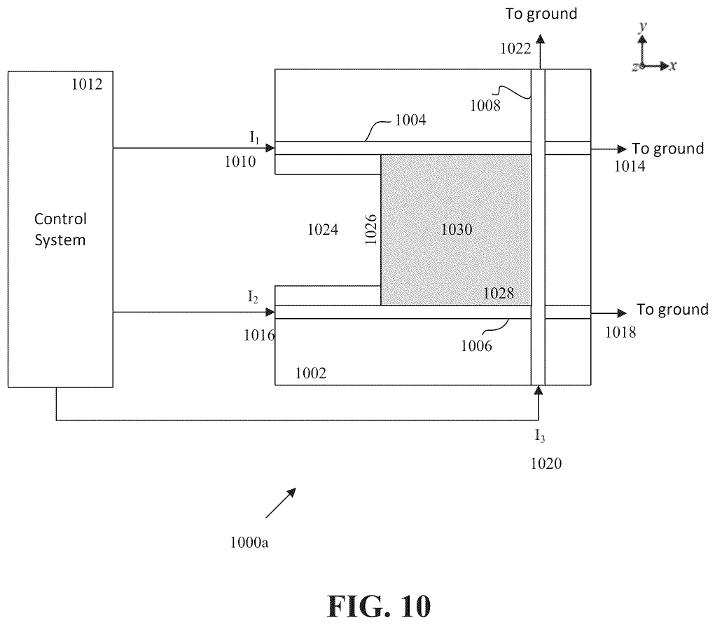

At the time 528, the control system 522 may also command, instruct, trigger, etc. an electromagnetic signal-generating system 530 to produce the electromagnetic signal 504 with the Bₓ component 506, the B_{y} component 508, and/or the B_{z} component 510. The electromagnetic signal-generating system 530 may be any electromagnetic signal-generating system described herein. In some examples, the electromagnetic signal-generating system 530 is separate from a quantum sensing system utilizing the quantum sensing process 500, as described in reference to the electromagnetic signal-generating system 102 and the quantum sensing system 100 of FIG. 1A. In some examples, the electromagnetic signal-generating system 530 is included in the quantum sensing system utilizing the quantum sensing process 500, as described in reference to the electromagnetic signal-generating system 102 and the quantum sensing system 100 of FIG. 1A. Also at the time 528, the control system 522 may command, instruct, trigger, etc. electromagnetic field generator 532, which may be any electromagnetic field generator described herein, to output an orthonormal electromagnetic field pulse sequence generated according to the pulse sequence 514. For instance, the electromagnetic field generator 532 may be electromagnetic field generator 1000a of FIG. 10, and the control system 522 may command, instruct, trigger, etc. the electromagnetic field generator 532 (e.g., 1000a) to output a net orthonormal circuit generated pulse sequence formed from a plurality of orthonormal electromagnetic field pulse sequences, such as described in reference to FIG. 10. The pulse sequence 514 is an exemplary embodiment of pulse sequence 108 of FIG. 1A. The orthonormal electromagnetic field pulse sequence generated according to the pulse sequence 514 may be applied to the at least one qubit. As such, applying the orthonormal electromagnetic field pulse sequence generated according to the pulse sequence 514 may constitute applying the pulse sequence 514 to the at least one qubit. The at least qubit may then accumulate phase representing the projection of the electromagnetic signal 504 onto a filter function inherent to the orthonormal electromagnetic field pulse sequence generated according to the pulse sequence 514 (e.g., phase measurement associated with coefficients of the filter function). The pulse sequence 514 and the electromagnetic signal 504 may have a duration 534. At a time 536, the pulse sequence 514 and the electromagnetic signal may terminate. For instance, the control system 522 may command, instruct, trigger, etc. the electromagnetic field generator 532 to terminate outputting the orthonormal electromagnetic field pulse sequence, and the control system 522 may command, instruct, trigger, etc. the electromagnetic signal-generating system 530 to terminate production of the electromagnetic signal 504. In some examples, the command, instruction, trigger, etc. at the time 528 may include the command, instruction, trigger, etc. for termination at the time 536. A person of skill in the art will appreciate that the control system 522 may be configured to provide a command, instruction, trigger, etc. to any other system in the quantum sensing process 500, and the any other system may act in response to receiving the command, instruction, trigger, etc. from the control system 522.

At the time 536, the control system 522 may also command, instruct, trigger, etc. the laser 524 to turn on (e.g., illuminate a diamond solid-state, such as described in reference to FIG. 3). After a duration 538, the control system 522 may command, instruct, trigger, etc. the laser 524 to turn off at a time 558. This modulation of the laser 524 via the control system 522 may be encapsulated in the second laser pulse 516, and the second laser pulse 516 triggers emission of electromagnetic radiation of the at least one qubit. The emitted electromagnetic radiation represents the accumulated phase of the at least one qubit. In some examples, the control system 522 may not command, instruct, trigger, etc. the laser 524 to turn off at the time 558. At the time 536 (e.g., during the second laser pulse 516), the control system 522 may command, instruct, trigger, etc. a camera system 541 to capture an image or a plurality of images. The camera system 541 is an exemplary embodiment of camera system 112 of FIG. 1A. The image or the plurality of images may capture the electromagnetic radiation emitted by the at least one qubit. The camera system 541 may capture the image or the plurality of images for the duration 538. After the duration 538, the control system 522 may command, instruct, trigger, etc. the camera system 541 to terminate capture of the image or the plurality of images at the time 558, and the control system 522 may receive, store, and/or process the image or the plurality of images. The capture of the image or the plurality of images may be encapsulated in the image capture 518. In some examples, the control system 522 determines at least one characteristic of the electromagnetic signal 504 based on the image or the plurality of images captured in the image capture 518. For instance, the control system 522 may approximate the magnetic field component of the electromagnetic signal 504 with a reconstruction equation (e.g., with Equation 1 or Equation 4) using the image or plurality of images (e.g., using the emitted electromagnetic radiation in the image or plurality of images). Based on the approximation of the magnetic field component of the electromagnetic signal 504, the control system 522 may determine at least one characteristic of the electromagnetic signal 504 (e.g., a spatial characteristic, a temporal characteristic, and/or a vectorial characteristic). In some examples, the command, instruction, trigger, etc. at the time 536 may include the command, instruction, trigger, etc. to terminate the capture of the image or the plurality of images at the time 558. In some examples, the control system 522 may command, instruct, trigger, etc. the camera system 541 to capture the image or the plurality of images with a phase (e.g., +I, −I, +Q, −Q), as described herein. For instance, the control system 522 may command, instruct, trigger, etc. the camera system 541 to capture the image or the plurality of images with a positive in-phase phase (+I). As such, the image or the plurality of images captured in the image capture 518 may be associated with a positive in-phase phase (+I). In some examples, the phase of the image or the plurality of images captured in the image capture 518 may be associated with a phase(s) of at least one pulse in the pulse sequence 514.

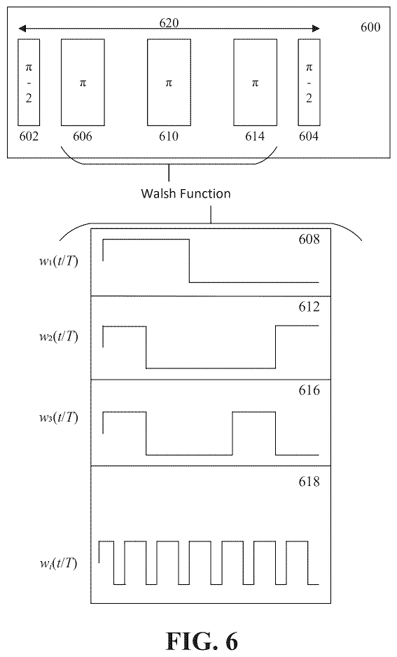

FIG. 6 illustrates an exemplary pulse sequence 600 associated with a Walsh basis, according to some examples. Although the following describes the pulse sequence 600 generated according to a Walsh basis, a person of skill in the art will appreciate that the pulse sequence 600 may be generated according to any basis that is orthonormal in time (or frequency). As such, the following description may be applicable to any pulse sequence used in any quantum sensing process and/or any quantum sensing system described herein. The pulse sequence 600 may include a first π/2-pulse 602 and a second π/2-pulse 604. In some examples, the first π/2-pulse 602 creates a superposition of quantum states of at least one qubit, which may be any qubit described herein. The second π/2-pulse may collapse the superposition of the quantum states (e.g., spin projection) of the at least one qubit. Collapsing the superposition of the quantum states may be relevant for emission of electromagnetic radiation of the at least one qubit. In some examples, the pulse sequence 600 includes a first π-pulse 606. The first π-pulse 606 may be represented by, or may itself be, a Walsh function with a Walsh order m=1. As such, the pulse sequence 600 may include the Walsh function 608. In some examples, the pulse sequence 600 may include a plurality of π-pulses, for instance the pulse sequence 600 may include the first π-pulse 606 and a second π-pulse 610. The π-pulse 606 and 610 may also be represented by, or may itself be, a Walsh function 612 with a Walsh order m=2. As such, the pulse sequence 600 may include the Walsh function 612. In some examples, the pulse sequence 600 also includes a third π-pulse 614, and the π-pulses 606, 610, and 614 may be represented by, or may itself be, a Walsh function 616 with a Walsh order m=3. As such, the pulse sequence 600 may include the Walsh function 616. In some examples, the pulse sequence 600 includes i π-pulses, which may also be represented by, or may itself be, a Walsh function 618 with a Walsh order m=i. As such, the pulse sequence 600 may include the Walsh function 618. The Walsh order m may be any integer. The minimum Walsh order may be associated with the number of frequency components of an electromagnetic signal, which may be any electromagnetic signal described herein. For instance, if the electromagnetic signal is a monochromatic electromagnetic signal, then the minimum Walsh order may be 1, such that increasing the Walsh order beyond m=1 reduces a reconstruction error, or an approximation error, associated with the reconstruction of the magnetic field component of the electromagnetic signal. If the electromagnetic signal has two frequency components, then the minimum Walsh order may be 2. The maximum Walsh order may be associated with the reconstruction error, or approximation error, of the magnetic field component of the electromagnetic signal. For instance, the maximum Walsh order may be increased until a pre-determined reconstruction error, or approximation error, is reached.

The plurality of pulses (e.g., π/2-pulse(s) and/or π-pulse(s)) in the pulse sequence 600 may be associated with an amplitude, phase, frequency (e.g., resonant frequency), duration (e.g., Rabi frequency), timing, shape, etc. For instance, the first π/2-pulse 602 and the second π/2-pulse 604 may be associated with a global phase, such as +X, −X, +Y, or −Y, with respect to the phase of the first π/2-pulse 602. As described herein, the phase of the second π/2-pulse 604 may be associated with the phase of an image or a plurality of images captured in an image capture in a quantum sensing process, such as the image capture 518 of the quantum sensing process 500 of FIG. 5. For instance, a negative global phase of the second π/2-pulse 604 (e.g., −X or −Y) may be associated with an image or a plurality of images captured in an image capture having a positive, or negative, in-phase relative phase (e.g., +I or −I). In some examples, a positive global phase of the second π/2-pulse 604 (e.g., +X or +Y) may be associated with an image or a plurality of images captured in an image capture having a positive, or negative, quadrature relative phase (e.g., +Q or −Q). The amplitude, phase, frequency, duration, timing, shape, etc. of the plurality of pulses may also be associated with the Walsh function with the Walsh order i. For instance, for a pulse sequence duration 620 (e.g., duration T described herein), the Walsh function with the Walsh order i may determine the timing and duration associated with the plurality of pulses in the pulse sequence 600, such that the plurality of pulses may be distributed in the pulse sequence duration 620.

Referring to FIG. 5, in some examples, the quantum sensing process 500 may include a plurality of sensing blocks, such as sensing block 540, sensing block 542, and/or sensing block 544. The sensing blocks 540, 542, and 544 may similarly include the electromagnetic signal 504 with the Bₓ component 506, the B_{y} component 508, and/or the B_{z} component 510, the first laser pulse 512, and the second laser pulse 516. The sensing block 540 may also include a pulse sequence 546 and an image capture 548. The pulse sequence 546 may be the same, or different, as the pulse sequence 514 of the sensing block 502, and the image capture 548 may be the same, or different, as the image capture 518 of the sensing block 502. Similarly, the sensing block 542 may also include a pulse sequence 550 and an image capture 552. The pulse sequence 550 may be the same, or different, as the pulse sequence 514 of the sensing block 502 and/or the pulse sequence 546 of the sensing block 540, and the image capture 552 may be the same, or different, as the image capture 518 of the sensing block 502 and/or the image capture 548 of the sensing block 540. The sensing block 544 may also include a pulse sequence 554 and an image capture 556. The pulse sequence 554 may be the same, or different, as the pulse sequence 514 of the sensing block 502, the pulse sequence 546 of the sensing block 540, and/or the pulse sequence 550 of the sensing block 542, and the image capture 556 may be the same, or different, as the image capture 518 of the sensing block 502, the image capture 548 of the sensing block 540, and/or the image capture 552 of the sensing block 542.

In some examples, the sensing block 540 follows the sensing block 502, such that the control system 522 commands, instructs, triggers, etc. the first laser pulse 512 of the sensing block 540 to begin at the time 558 at which the second laser pulse 516 of the sensing block 502 was terminated by the control system 522. The control system 522 may simultaneously command, instruct, trigger, etc. the second laser pulse 516 of the sensing block 502 and the first laser pulse 512 of the sensing block 540. In some examples, as described herein, the control system 522 does not command, instruct, trigger, etc. the second laser pulse 516 of the sensing block 502 to terminate at the time 558, such that the laser 524 remains on and the second laser pulse 516 of the sensing block 502 combines with the first laser pulse 512 of the sensing block 540 to form a laser pulse 559. Thus, during the image capture 518 of the sensing block 502, the laser pulse 559 may trigger emission of the electromagnetic radiation of the at least one qubit (e.g., spin projection), then beginning at the time 558, the laser pulse 559 may initialize the at least one qubit to the first quantum state for a duration 560. The laser pulse 559 may have a duration equal to the duration 538 plus the duration 560.

At a time 562, the control system 522 may command, instruct, trigger, etc. the laser 524 to turn off, such that the first laser pulse 512 of the sensing block 540 may terminate or such that the laser pulse 559 may terminate. Also at the time 562, the control system 522 may command, instruct, trigger, etc. the electromagnetic signal-generating system 530 to produce the electromagnetic signal 504 with the Bₓ component 506, the B_{y} component 508, and/or the B_{z} component 510. The repeated production (e.g., repeated triggerings) of the electromagnetic signal 504 via command, instruct, trigger, etc. from the control system 522 may ensure the electromagnetic signal 504 has at least one characteristic consistent at the time 562 as at the time 528 (e.g., at least one characteristic consistent at each start of the electromagnetic signal 504).

The at least one consistent characteristic of the electromagnetic signal 504 may ensure that the at least one qubit is exposed to the same electromagnetic signal 504 during the application of the pulse sequence 546 of sensing block 540 and during the application of the pulse sequence 514 of the sensing block 502. Being exposed to the same electromagnetic signal 504 may ensure that the emitted electromagnetic radiation resulting from the application of the pulse sequence 546 and the application of the pulse sequence 514 can be used to reconstruct the magnetic field component of the electromagnetic signal 504 using a reconstruction equation (e.g., using Equation 1 or Equation 4). The at least one consistent characteristic of the electromagnetic signal 504 may be any characteristic associated with the electromagnetic signal 504, for instance a consistent amplitude characteristic or a consistent phase characteristic. For instance, the electromagnetic signal 504 may have the same amplitude at the time 562 as it did at the time 528 (e.g., consistent amplitude characteristic). The electromagnetic signal 504 may have the same phase at the time 562 as it did at the time 528 (e.g., consistent phase characteristic).

Also at the time 562, the control system 551 may command, instruct, trigger, etc. the electromagnetic field generator 532, such that the electromagnetic field generator 532 may output an orthonormal electromagnetic field pulse sequence generated according to the pulse sequence 546. The pulse sequence 546 may be any pulse sequence described herein, for instance the pulse sequence 600 of FIG. 6 or the pulse sequence 108 of FIG. 1. The orthonormal electromagnetic field pulse sequence generated according to the pulse sequence 546 may be applied to the at least one qubit (e.g., nitrogen vacancy center defect). As such, applying the orthonormal electromagnetic field pulse sequence generated according to the pulse sequence 546 may constitute applying the pulse sequence 546 to the at least one qubit. Applying the orthonormal electromagnetic field pulse sequence to the at least one qubit may similarly cause the at least one qubit to accumulate phase representing the projection of the electromagnetic signal 504 onto the filter function inherent to the orthonormal electromagnetic field pulse sequence (e.g., inherent to the pulse sequence 546). The pulse sequence 546 (e.g., the orthonormal electromagnetic field pulse sequence) and the electromagnetic signal 504 may have a duration 564, which may be the same, or different, as the duration 534. At a time 566, the pulse sequence 546 and the electromagnetic signal 504 may terminate. For instance, the control system 522 may command, instruct, trigger, etc. the electromagnetic field generator 532 to terminate the output of the orthonormal electromagnetic field pulse sequence generated according to the pulse sequence 546. At the time 566, the control system 522 may command, instruct, trigger, etc. the electromagnetic signal-generating system 530 to terminate production of the electromagnetic signal 504. In some examples, the command, instruction, trigger, etc. at the time 562 may include the command, instruction, trigger, etc. for termination at the time 566.

At the time 566, the control system 522 may also command, instruct, trigger, etc. the laser 524 to turn on (e.g., illuminate a diamond solid-state such as described in reference to FIG. 3). After a duration 568, the control system 522 may command, instruct, trigger, etc. the laser 524 to turn off. This modulation of the laser 524 via the control system 522 may be encapsulated in the second laser pulse 516 of the sensing block 540, and the second laser pulse 516 may trigger emission of electromagnetic radiation of the at least one qubit. Also at the time 566 (e.g., during the second laser pulse 516 of the sensing block 540), the control system 522 may command, instruct, trigger, etc. a camera system 541 to capture an image or a plurality of images. The image or the plurality of images may capture the electromagnetic radiation emitted by the at least one qubit. The camera system 541 may capture the image or the plurality of images for the duration 568. After the duration 568 (e.g., at a time 570), the control system 522 may command, instruct, trigger, etc. the camera system 541 to terminate capture of the image or the plurality of images, and the control system 522 may receive, store, and/or process the image or the plurality of images. The capture of the image or the plurality of images may be encapsulated in image capture 548. In some examples, the command, instruction, trigger, etc. at the time 566 may include the command, instruction, trigger, etc. to terminate the capture of the image or the plurality of images at the time 570. The image or the plurality of images captured in the image capture 548 may be associated with a phase. The phase of the image or the plurality of images captured in the image capture 548 may be associated with a phase of at least one pulse in the pulse sequence 546. For instance, a second π/2-pulse in the pulse sequence 546 may have a positive phase (e.g., +X or +Y), such as described in reference to FIG. 6, such that the image or the plurality of images captured in the image capture 548 may be associated with a positive quadrature phase (e.g., +Q).

In some examples, the control system 522 determines at least one characteristic of the electromagnetic signal 504 based on the image or the plurality of images captured in the image capture 548. For instance, the control system 522 may approximate the magnetic field component of the electromagnetic signal 504 with a reconstruction equation (e.g., with Equation 1 or Equation 4) using the image or plurality of images (e.g., using the emitted electromagnetic radiation in the image or plurality of images). Based on the approximation of the magnetic field component of the electromagnetic signal 504, the control system 522 may determine at least one characteristic of the electromagnetic signal 504 (e.g., a spatial characteristic, a temporal characteristic, and/or a vectorial characteristic). In some examples, the control system 522 determines at least one characteristic of the electromagnetic signal 504 based on the image or plurality of images captured in the image capture 548 and the image or plurality of images captured in the image capture 518. For instance, the control system 522 may linearly combine, or average, the image (or plurality of images) captured in the image capture 518 and the image (or the plurality of images) captured in the image capture 548 to form a final image or a plurality of final images. Using the final image or the plurality of final images (e.g., using the emitted electromagnetic radiation in the final image or plurality of final images), the control system 522 may approximate the magnetic field component of the electromagnetic signal 504 using a reconstruction equation (e.g., using Equation 1 or Equation 4). Based on the approximation of the magnetic field component of the electromagnetic signal 504, the control system 522 may determine at least one characteristic of the electromagnetic signal 504. In some examples, the control system 522 may use the image (or the plurality of images) captured in the image capture 548 and the image (or plurality of images) captured in the image capture 518 to approximate the magnetic field component of the electromagnetic signal 504 with a reconstruction equation (e.g., with Equation 1 or Equation 4). The control system 522 may then linearly combine (or average) the approximations of the magnetic field component of the electromagnetic signal 504 to form a final approximation of the magnetic field component of the electromagnetic signal 504. Based on the final approximation of the magnetic field component of the electromagnetic signal 504, the control system 522 may determine at least one characteristic of the electromagnetic signal 504.

In some examples, the sensing block 542 follows the sensing block 540, such that the control system 522 commands, instructs, triggers, etc. the first laser pulse 512 of the sensing block 542 to begin at the time 570 at which the second laser pulse 516 of the sensing block 540 was terminated by the control system 522. The control system 522 may simultaneously command, instruct, trigger, etc. the second laser pulse 516 of the sensing block 540 and the first laser pulse 512 of the sensing block 542. In some examples, as described herein, the control system 522 does not command, instruct, trigger, etc. the second laser pulse 516 of the sensing block 540 to terminate at the time 570, such that the laser 524 remains on and the second laser pulse 516 of the sensing block 540 combines with the first laser pulse 512 of the sensing block 542 to form a laser pulse 569. Thus, during the image capture 548 of the sensing block 540, the laser pulse 569 may trigger emission of the electromagnetic radiation of the at least one qubit (e.g., spin projection), then beginning at the time 570, the laser pulse 569 may initialize the at least one qubit to the first quantum state for a duration 572. The laser pulse 569 may have a duration equal to the duration 568 plus the duration 572.

At a time 574, the control system 551 may command, instruct, trigger, etc. the laser 524 to turn off, such that the first laser pulse 512 of the sensing block 542 may terminate or such that the laser pulse 569 may terminate. Also at the time 574, the control system 551 may command, instruct, trigger, etc. the electromagnetic signal-generating system 530 to produce the electromagnetic signal 504 with the Bₓ component 506, the B_{y} component 508, and/or the B_{z} component 510. The repeated production (e.g., repeated triggerings) of the electromagnetic signal 504 via command, instruct, trigger, etc. from the control system 522 may ensure the electromagnetic signal 504 has the at least one characteristic consistent at the time 574 as at the time 562 and as at the time 528 (e.g., the at least one characteristic consistent at each start, or production, of the electromagnetic signal 504). The at least one consistent characteristic of the electromagnetic signal 504 may ensure that the at least one qubit is exposed to the same electromagnetic signal 504 during the application of the pulse sequence 550 of the sensing block 542, during the application of the pulse sequence 546 of sensing block 540, and during the application of the pulse sequence 514 of the sensing block 502.

Also at the time 574, the control system 522 may command, instruct, trigger, etc. the electromagnetic field generator 532, such that the electromagnetic field generator 532 may output an orthonormal electromagnetic field pulse sequence generated according to the pulse sequence 550. The pulse sequence 550 may be any pulse sequence described herein, for instance the pulse sequence 600 of FIG. 6. The orthonormal electromagnetic field pulse sequence generated according to the pulse sequence 550 may be applied to the at least one qubit. As such, applying the orthonormal electromagnetic field pulse sequence generated according to the pulse sequence 550 may constitute applying the pulse sequence 550 to the at least one qubit. The pulse sequence 550 and the electromagnetic signal 504 may have a duration 576, which may be the same, or different, as the duration 534 and/or the duration 564. At a time 578, the pulse sequence 550 and the electromagnetic signal 504 may terminate. For instance, the control system 522 may command, instruct, trigger, etc. the electromagnetic field generator 532 to terminate the output of the pulse sequence 550, and the control system 522 may command, instruct, trigger, etc. the electromagnetic signal-generating system 530 to terminate production of the electromagnetic signal 504. In some examples, the command, instruction, trigger, etc. at the time 574 may include the command, instruction, trigger, etc. for termination at the time 578.

At the time 578, the control system 522 may also command, instruct, trigger, etc. the laser 524 to turn on (e.g., illuminate a diamond solid-state such as described in reference to FIG. 3). After a duration 580, the control system 522 may command, instruct, trigger, etc. the laser 524 to turn off. This modulation of the laser 524 via the control system 522 may be encapsulated in the second laser pulse 516 of the sensing block 542, and the second laser pulse 516 may trigger emission of electromagnetic radiation of the at least one qubit, such as described herein. Also at the time 578 (e.g., during the second laser pulse 516 of the sensing block 542), the control system 522 may command, instruct, trigger, etc. a camera system 541 to capture an image or a plurality of images. The image or the plurality of images may capture the electromagnetic radiation emitted by the at least one qubit. The camera system 541 may capture the image or the plurality of images for the duration 580. After the duration 580 (e.g., at a time 582), the control system may command, instruct, trigger, etc. the camera system 541 to terminate capture of the image or the plurality of images, and the control system 522 may receive, store, and/or process the image or the plurality of images. The capture of the image or the plurality of images may be encapsulated in the image capture 552. In some examples, the command, instruction, trigger, etc. at the time 578 may include the command, instruction, trigger, etc. to terminate the capture of the image or the plurality of images at the time 582. The image or the plurality of images captured in the image capture 552 may be associated with a phase. The phase of the image or the plurality of images captured in the image capture 552 may be associated with a phase of at least one pulse in the pulse sequence 550. For instance, a second π/2-pulse in the pulse sequence 550 may have a negative phase (e.g., −X or −Y), such that the image or the plurality of images captured in the image capture 552 may be associated with a negative in-phase phase (e.g., −I), such as described in FIG. 6.

In some examples, the control system 522 determines at least one characteristic of the electromagnetic signal 504 based on the image or the plurality of images captured in the image capture 552. For instance, the control system 522 may approximate the magnetic field component of the electromagnetic signal 504 with a reconstruction equation (e.g., with Equation 1 or Equation 4) using the image or plurality of images (e.g., using the emitted electromagnetic radiation in the image or plurality of images). Based on the approximation of the magnetic field component of the electromagnetic signal 504, the control system 522 may determine at least one characteristic of the electromagnetic signal 504 (e.g., a spatial characteristic, a temporal characteristic, and/or a vectorial characteristic). In some examples, the control system 522 determines at least one characteristic of the electromagnetic signal 504 based on the image or plurality of images captured in the image capture 552, the image or plurality of images captured in the image capture 548, and/or the image or plurality of images captured in the image capture 518. For instance, the control system 522 may linearly combine, or average, the image (or plurality of images) captured in the image capture 518, the image (or the plurality of images) captured in the image capture 548, and/or the image (or the plurality of images) captured in the image capture 552 to form a final image or a plurality of final images. Using the final image or the plurality of final images (e.g., using the emitted electromagnetic radiation in the final image or plurality of final images), the control system 522 may approximate the magnetic field component of the electromagnetic signal 504 with a reconstruction equation (e.g., with Equation 1 or Equation 4). Based on the approximation of the magnetic field component of the electromagnetic signal 504, the control system 522 may determine at least one characteristic of the electromagnetic signal 504. In some examples, the control system 522 may use the image (or the plurality of images) captured in the image capture 552, the image (or the plurality of images) captured in the image capture 548, and/or the image (or plurality of images) captured in the image capture 518 to approximate the magnetic field component of the electromagnetic signal 504 with a reconstruction equation (e.g., with Equation 1 or Equation 4). The control system 522 may then linearly combine (or average) the approximations of the magnetic field component of the electromagnetic signal 504 to form a final approximation of the electromagnetic signal 504. Based on the final approximation of the magnetic field component of the electromagnetic signal 504, the control system 522 may determine at least one characteristic of the electromagnetic signal 504.

In some examples, the sensing block 544 follows the sensing block 542, such that the control system 522 commands, instructs, triggers, etc. the first laser pulse 512 of the sensing block 544 to begin at the time 582 at which the second laser pulse 516 of the sensing block 542 was terminated by the control system 522. The control system 522 may simultaneously command, instruct, trigger, etc. the second laser pulse 516 of the sensing block 542 and the first laser pulse 512 of the sensing block 544. In some examples, such as described herein, the control system 522 does not command, instruct, trigger, etc. the second laser pulse 516 of the sensing block 542 to terminate at the time 582, such that the laser 524 remains on and the second laser pulse 516 of the sensing block 542 combines with the first laser pulse 512 of the sensing block 544 to form a laser pulse 579. Thus, during the image capture 552 of the sensing block 542, the laser pulse 579 may trigger emission of the electromagnetic radiation of the at least one qubit (e.g., spin projection), then beginning at the time 582, the laser pulse 579 may initialize the at least one qubit to the first quantum state for a duration 584. The laser pulse 579 may have a duration equal to the duration 580 plus the duration 584.

At a time 586, the control system 522 may command, instruct, trigger, etc. the laser 524 to turn off, such that the first laser pulse 512 of the sensing block 544 may terminate or such that the laser pulse 579 may terminate. Also at the time 586, the control system 551 may command, instruct, trigger, etc. the electromagnetic signal-generating system 530 to produce the electromagnetic signal 504 with the Bₓ component 506, the B_{y} component 508, and/or the B_{z} component 510. The repeated production (e.g., repeated triggerings) of the electromagnetic signal 504 via command, instruct, trigger, etc. from the control system 522 may ensure the electromagnetic signal 504 has at least one characteristic consistent at the time 586 as at the time 574, as at the time 562, and as at the time 528 (e.g., at least one characteristic consistent at each start, or production, of the electromagnetic signal 504). The at least one characteristic consistent at each production time of the electromagnetic signal 504 may ensure that the at least one qubit is exposed to the same electromagnetic signal 504 during the application of the pulse sequence 554 of the sensing block 544, during the application of the pulse sequence 550 of the sensing block 542, during the application of the pulse sequence 546 of the sensing block 540, and during the application of the pulse sequence 514 of the sensing block 502. The at least one consistent characteristic of the electromagnetic signal 504 may be any characteristic associated with the electromagnetic signal 504, for instance a consistent amplitude characteristic or a consistent phase characteristic.

Also at the time 586, the control system 522 may command, instruct, trigger, etc. the electromagnetic field generator 532, such that the electromagnetic field generator 532 may output an orthonormal electromagnetic field pulse sequence generated according to the pulse sequence 554. The pulse sequence 554 may be any pulse sequence described herein, for instance the pulse sequence 600 of FIG. 6. The orthonormal electromagnetic field pulse sequence generated according to the pulse sequence 554 may be applied to the at least one qubit. As such, applying the orthonormal electromagnetic field pulse sequence generated according to the pulse sequence 554 may constitute applying the pulse sequence 554 to the at least one qubit. The pulse sequence 554 and the electromagnetic signal 504 may have a duration 588, which may be the same, or different, as the duration 534, the duration 564, and/or the duration 576. At a time 590, the pulse sequence 554 and the electromagnetic signal 504 may terminate. For instance, the control system 522 may command, instruct, trigger, etc. the electromagnetic field generator 532 to terminate the output of the pulse sequence 554, and the control system 522 may command, instruct, trigger, etc. the electromagnetic signal-generating system 530 to terminate production of the electromagnetic signal 504. In some examples, the command, instruction, trigger, etc. at the time 586 may include the command, instruction, trigger, etc. for termination at the time 590.

At the time 590, the control system 522 may also command, instruct, trigger, etc. the laser 524 to turn on (e.g., illuminate a diamond solid-state such as described in reference to FIG. 3). After a duration 592, the control system 522 may command, instruct, trigger, etc. the laser 524 to turn off. This modulation of the laser 524 via the control system 522 may be encapsulated in the second laser pulse 516 of the sensing block 544, and the second laser pulse 516 may trigger emission of electromagnetic radiation of the at least one qubit, such as described herein. Also at the time 590 (e.g., during the second laser pulse 516 of the sensing block 542), the control system 522 may command, instruct, trigger, etc. a camera system 541 to capture an image or a plurality of images. The image or the plurality of images may capture the electromagnetic radiation emitted by the at least one qubit. The camera system 541 may capture the image or the plurality of images for the duration 592. After the duration 592 (e.g., at a time 594), the control system may command, instruct, trigger, etc. the camera system 541 to terminate capture of the image or the plurality of images, and the control system 522 may receive, store, and/or process (e.g., determine at least one characteristic of the electromagnetic signal 504) the image or the plurality of images. The capture of the image or the plurality of images may be encapsulated in the image capture 556. In some examples, the command, instruction, trigger, etc. at the time 590 may include the command, instruction, trigger, etc. to terminate the capture of the image or the plurality of images at the time 594. The image or the plurality of images captured in the image capture 556 may be associated with a phase. The phase of the image or the plurality of images captured in the image capture 556 may be associated with a phase of at least one pulse in the pulse sequence 554. For instance, a second π/2-pulse in the pulse sequence 554 may have a positive phase (e.g., +X or +Y), such that the image or the plurality of images captured in the image capture 556 may be associated with a negative quadrature phase (e.g., +Q), such as described in FIG. 6.

In some examples, the control system 522 determines at least one characteristic of the electromagnetic signal 504 based on the image or the plurality of images captured in the image capture 556. For instance, the control system 522 may approximate the magnetic field component of the electromagnetic signal 504 with a reconstruction equation (e.g., with Equation 1 or Equation 4) using the image or plurality of images (e.g., using the emitted electromagnetic radiation in the image or plurality of images). Based on the approximation of the magnetic field component of the electromagnetic signal 504, the control system 522 may determine at least one characteristic of the electromagnetic signal 504 (e.g., a spatial characteristic, a temporal characteristic, and/or a vectorial characteristic). In some examples, the control system 522 determines at least one characteristic of the electromagnetic signal 504 based on the image or plurality of images captured in the image capture 556, the image or plurality of images captured in the image capture 552, the image or plurality of images captured in the image capture 548, and/or the image or plurality of images captured in the image capture 518. For instance, the control system 522 may linearly combine, or average, the image (or plurality of images) captured in the image capture 518, the image (or the plurality of images) captured in the image capture 548, the image (or the plurality of images) captured in the image capture 552, and/or the image (or the plurality of images) captured in the image capture 556 to form a final image or a plurality of final images. For instance, the image or plurality of images captured in the image capture 518, which may be associated with a positive in-phase phase (e.g., +I), and the image or plurality of images captured in the image capture 552, which may be associated with a negative in-phase phase (e.g., −I), may be linearly combined to form an image or a plurality of images associated with a phase I (e.g., an I image or a plurality of I images). Similarly, the image or plurality of images captured in the image capture 548, which may be associated with a positive quadrature phase (e.g., +Q), and the image or plurality of images captured in the image capture 556, which may be associated with a negative quadrature phase (e.g., −Q), may be linearly combined to form an image or a plurality of images associated with a phase Q (e.g., a Q image or a plurality of Q images). In some examples, the I image (or plurality of I images) are linearly combined with the Q image (or the plurality of Q images) to form a final image (or plurality of final images) with an intensity A=\sqrt{I²+Q²} and a net phase. In some examples, the image or plurality of images associated with a positive in-phase phase (e.g., captured in the image capture 518), the image or plurality of images associated with a negative in-phase phase (e.g., captured in the image capture 552), the image or the plurality of images associated with a positive quadrature phase (e.g., captured in the image capture 548), and the image or the plurality of images associated with a negative quadrature phase (e.g., captured in the image capture 556) may be linearly combined to form the final image, or plurality of final images with the intensity A=\sqrt{I²+Q²} and a net phase. As such, the final image (or the plurality of images) may include, or be formed from, at least one image component with a positive in-phase phase, at least one image component with a negative in-phase phase, at least one image component with a positive quadrature phase, and at least one image component with a negative quadrature phase. The final image may be referred to as a Walsh image hereafter when the orthonormal electromagnetic field pulse sequences are generated according to pulse sequences having a Walsh basis. The Walsh image may represent one element of the Walsh basis (e.g., element m, or Walsh order, such as described in reference to Equation 4). Using the final image or the plurality of final images (e.g., using the emitted electromagnetic radiation in the final image or the plurality of final images), the control system 522 may approximate the magnetic field component of the electromagnetic signal 504 with a reconstruction equation (e.g., with Equation 1 or Equation 4). Based on the approximation of the magnetic field component of the electromagnetic signal 504, the control system 522 may determine at least one characteristic of the electromagnetic signal 504.

In some examples, the control system 522 may use the image (or plurality of images) captured in the image capture 556, the image (or the plurality of images) captured in the image capture 552, the image (or the plurality of images) captured in the image capture 548, and the image (or plurality of images) captured in the image capture 518 to approximate the magnetic field component of the electromagnetic signal 504 with a reconstruction equation (e.g., with Equation 1 or Equation 4). The control system 522 may then linearly combine (or average) the approximations of the magnetic field component of the electromagnetic signal 504 to form a final approximation of the magnetic field component of the electromagnetic signal 504. Based on the final approximation of the magnetic field component of the electromagnetic signal 504, the control system 522 may determine at least one characteristic of the electromagnetic signal 504.

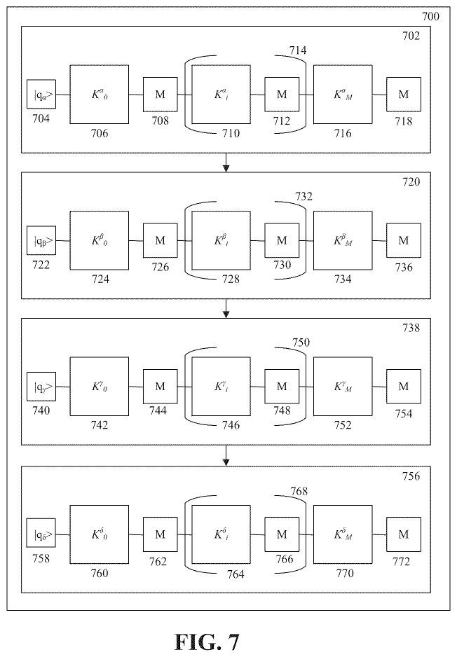

In some examples, the sensing blocks 502, 540, 542, and 544 may be repeated for N iterations 596. The minimum number of N iterations 596 may be associated with n+1, where n is the number of frequency components of the electromagnetic signal 504. For instance, if the electromagnetic signal is a monochromatic electromagnetic signal 504 (e.g., one frequency component), then the minimum number of N iterations 596 may be 2. For a first iteration of the 2 minimum N iterations 596, the pulse sequences 514, 546, 550, and 554 may be generated according to a Walsh function with Walsh order m=0. For a second iteration of the 2 minimum N iterations 596, the pulse sequences 514, 546, 550, and 554 may be associated with a Walsh function with Walsh order m=1. Additional iterations may reduce a reconstruction error, or an approximation error, associated with the reconstruction of the magnetic field component of the electromagnetic signal 504. As such, the maximum number of N iterations 596 may be associated with the reconstruction error, or approximation error, of the magnetic field component of the electromagnetic signal 504. For instance, the maximum number of N iterations 596 may be increased until a pre-determined reconstruction error, or approximation error, is reached. In some examples, for each iteration of the N iterations 596, the filter function inherent to the pulse sequences 514, 546, 550, and 554 of the sensing blocks 502, 540, 542 and 544, respectively, may be altered, such as described in reference to FIG. 7. In some examples, for each iteration of the N iterations 596, the filter function inherent to the pulse sequences 514, 546, 550, and 554 are not altered, such that the control system 522 may linearly combine the plurality of images captured in the N iterations 596 of the image captures 518, 548, 552, and 556 following the N iterations 596 (e.g., average the plurality of images). After the N iterations 596, the filter function inherent to the pulse sequences 514, 546, 550, and 554 may then be altered and N iterations 596 may be performed with the altered pulse sequences. In some examples, after N iterations 596, the carrier frequency (e.g., the resonant frequency) inherent to the pulse sequences 514, 546, 550, and 554 of the sensing blocks 502, 540, 542 and 544, respectively, may be altered, and the sensing blocks 502, 540, 542, and 544 may be repeated for N iterations 596, such as described in reference to FIG. 7.

In some examples, the control system 522 may approximate the magnetic field component of the electromagnetic signal 504 with a reconstruction equation (e.g., with Equation 1 or Equation 4) using the plurality of images captured in the image captures 518, 548, 552, and 556 following each iteration of the N iterations 596, thus yielding N approximations of the magnetic field component of the electromagnetic signal 504. After N iterations 596, the control system 522 may linearly combine the N approximations to form a final approximation of the magnetic field component of the electromagnetic signal 504. Based on the final approximation, the control system 522 may determine at least one characteristic of the electromagnetic signal 504. In some examples, the control system 522 uses the N approximations to make a video depicting the temporal, spatial, and/or vectorial characteristics of the electromagnetic signal 504. The video may be stored, displayed, and/or processed by the control system 522.

In some examples, the control system 522 may linearly combine the plurality of images captured in the image captures 518, 548, 552, and 556 following each iteration of the N iterations 596, thus yielding a final image or a plurality of final images for each iteration of the N iterations 596. The control system 522 may store the final image or the plurality of final images for each iteration of the N iterations 596. After the N iterations 596, the control system 522 may have N final images or N plurality of final images stored. Using the N final images or the N plurality of final images, the control system 522 may approximate the magnetic field component of the electromagnetic signal 504 with a reconstruction equation (e.g., with Equation 1 or Equation 4). In some examples, the control system 522 may linearly combine the N final images or the N plurality of final images to form a final image or a plurality of final images. Using the final image or the plurality of final images, the control system 522 may approximate the magnetic field component of the electromagnetic signal 504 with a reconstruction equation (e.g., with Equation 1 or Equation 4). Based on the approximation of the magnetic field component of the electromagnetic signal 504, the control system 522 may determine at least one characteristic of the electromagnetic signal 504. In some examples, the control system 522 may use the N final images or the N plurality of final images to make a video, and the video may be stored, displayed, and/or processed by the control system 522. In some examples, the approximation of the magnetic field component of the electromagnetic signal 504 may be in the form of a video, and the video may be stored, displayed, and/or processed by the control system 522.

In some examples, the sensing block 502 may be proceeded by a plurality of commands, instructions, triggers, etc. from the control system 522 to other systems, for instance a TTL (transistor-transistor logic) pulse generator. In some examples, the N iterations 596 of the sensing blocks 502, 540, 542, and 544 may also be proceeded by a plurality of commands, instructions, trigger, etc. from the control system 522 to other systems. In some examples, the quantum sensing process 500 may be proceeded by a method for determining one or more quantum state frequencies of the at least one qubit, such as method 1250 described in FIG. 12B, or by a method for determining a Rabi frequency of the at least one qubit, such as method 1280 of FIG. 12C.

In some examples, the final image or the plurality of final images obtained via the quantum sensing process 500 (e.g., the sensing blocks 502, 540, 542, and 544) is represented by the circuit representation 595, which may include a qubit representation 597, a pulse sequence representation 598, and a measurement representation 599. The qubit representation 597 may illustrate that the quantum sensing process 500 may be applied to the at least one qubit. For instance, the at least one qubit, q, may be a nitrogen vacancy center defect, such as described herein, and the nitrogen vacancy center defect may have a crystallographic orientation k (e.g., α, β, γ, δ), such as described herein. The pulse sequence representation 598 may represent the quantum sensing process 500 (e.g., the sensing blocks 502, 540, 542, and 544), where

$${K}_{i}^{k}$$

may represent performing the quantum sensing process 500 (e.g., K) may be performed with the pulse sequence 514, the pulse sequence 546, the pulse sequence 550, and the pulse sequence 554 generated according to a filter function of order i. For instance, the pulse sequence 514, 546, 550, and 554 may be Walsh pulse sequences. The measurement representation 599 may represent obtaining the final image (or the plurality of final images) by linearly combining the images (or the plurality of images) captured in the image capture 518, the images (or the plurality of images) captured in the image capture 548, the images (or the plurality of images) captured in the image capture 552, and the images (or the plurality of images) captured in the image capture 556 (e.g., linearly combining the plurality of images resulting from the pulse sequence representation 598).

As such, the circuit representation 595 may describe performing the quantum sensing process 500 and obtaining the final image (or the plurality of final images) for a given orientation k of the at least one qubit q (e.g., nitrogen vacancy center defect). FIG. 7 illustrates an exemplary method 700 of performing a quantum sensing process utilizing pulse sequences generated according to a Walsh basis at a plurality of orientations k of at least one nitrogen vacancy center defect (e.g., qubit), according to some examples. The method 700 may be relevant for determining a vectorial characteristic of an electromagnetic signal, such as electromagnetic signal 504 of FIG. 5. A person of skill in the art will appreciate that the method 700 may be performed using pulse sequences generated according to any basis that is orthonormal in time (or frequency).

Step 702 may include a plurality of quantum sensing processes performed on at least one nitrogen vacancy center defect with an α crystallographic orientation, such as described in FIGS. 2A and 2B. The at least one nitrogen vacancy center defect with the α crystallographic orientation may be represented by a qubit representation 704. As such, the pulse sequences in the quantum sensing processes of the step 702 are generated according to a carrier frequency of a resonant frequency associated with the α crystallographic orientation. In some examples, the resonant frequency is determined using a method for determining one or more resonant frequencies, such as method 1250 of FIG. 12B. In some examples, the resonant frequency associated with the α crystallographic orientation is previously known or determined.

The step 702 may include a first pulse sequence representation 706 which may represent performing a quantum sensing process using pulse sequences generated according to a Walsh function with order m=0. The quantum sensing process using pulse sequences generated according to the Walsh function with order m=0 may yield a first Walsh image (or a plurality of first Walsh images). Obtaining the first Walsh image (or the plurality of first Walsh images) may be represented by a first measurement representation 708. The step 702 may then repeat a pulse sequence representation 710 followed by a measurement representation 712 for N iterations 714, such that after the N iterations 714, N+1 Walsh images (or N+1 pluralities of Walsh images) may have been obtained. The pulse sequence representation 710 may represent performing a quantum sensing process using pulse sequences generated according to a Walsh function with a Walsh order m=i. For each iteration of the N iterations 714, the Walsh order associated with the pulse sequence representation 710 may increase by an integer. For instance, the Walsh order may increase by 1 for each iteration of the N iterations 714 up to a Walsh order N of the Nth iteration of the N iterations 714. The N of the N iterations 714 may be any integer greater than 0 and less than or equal to M, where M may be the largest Walsh order of the step 702. Following the N iterations 714, the step 702 may include a final pulse sequence representation 716, and the final pulse sequence representation 716 may represent performing a quantum sensing process using pulse sequences generated according to a Walsh function with a Walsh order m=M. The quantum sensing process with the Walsh function of Walsh order m=M may yield a final Walsh image (or a plurality of final Walsh images), which may be represented in the step 702 by a final measurement representation 718.

The plurality of Walsh images obtained in the step 702 may total N+2 (e.g., N+2 Walsh images or N+2 pluralities of Walsh images). In some examples, the plurality of Walsh images obtained in the first step total N+1 (e.g., may occur when N=M). In some examples, the plurality of Walsh images obtained in the step 702 is stored by a control system, such as control system 104 of FIG. 1A. In some examples, the plurality of Walsh images obtained in the step 702 is used to approximate the magnetic field component of an electromagnetic signal using a reconstruction equation (e.g., using Equation 4). Based on the approximation, at least one characteristic of the electromagnetic signal may be determined (e.g., a spatial, a vectorial, and/or a temporal characteristic). However, a vectorial characteristic of the electromagnetic signal may be unable to be determined using the plurality of Walsh images obtained in the step 702.

A step 720 may include a plurality of quantum sensing processes performed on at least one nitrogen vacancy center defect with an β crystallographic orientation, such as described in FIGS. 2A and 2B. The at least one nitrogen vacancy center defect with the β crystallographic orientation may be represented by a qubit representation 722. As such, the pulse sequences in the quantum sensing processes of the step 720 are generated according to a carrier frequency of a resonant frequency associated with the β crystallographic orientation. In some examples, the resonant frequency was determined using method 1250 of FIG. 12B. In some examples, the resonant frequency associated with the β crystallographic orientation is determined when the resonant frequency associated with the α crystallographic orientation is determined using a method for determining one or more resonant frequencies, such as method 1250 of FIG. 12B. In some examples, the resonant frequency associated with the β crystallographic orientation is previously known or determined.

The step 720 may include a first pulse sequence representation 724 which may represent performing a quantum sensing process using pulse sequences generated according to a Walsh function with order m=0. The quantum sensing process using a Walsh function with order m=0 may yield a first Walsh image (or a plurality of first Walsh images), which may be represented in the step 720 by a first measurement representation 726. The step 720 may then repeat a pulse sequence representation 728 followed by a measurement representation 730 for N iterations 732, such that after the N iterations 732, N+ 1 Walsh images (or N+1 pluralities of Walsh images) may have been obtained. The pulse sequence representation 728 may represent performing a quantum sensing process using a Walsh function with a Walsh order m=i. For each iteration of the N iterations 714, the Walsh order associated with the pulse sequence representation 728 may increase by an integer. For instance, the Walsh order may increase by 1 for each iteration of the N iterations 732 up to a Walsh order N of the Nth iteration of the N iterations 732. The N of the N iterations 732 may be any integer greater than 0 and less than or equal to M, where M may be the largest Walsh order. Following the N iterations 732, the step 720 may include a final pulse sequence representation 734, and the final pulse sequence representation 734 may represent performing a quantum sensing process using a Walsh function with a Walsh order m=M. The quantum sensing process with the Walsh function of Walsh order m=M may yield a final Walsh image (or a plurality of final Walsh images), which may be represented in the step 720 by a final measurement representation 736.

The plurality of Walsh images obtained in the step 720 may total N+2 (e.g., N+2 Walsh images or N+2 pluralities of Walsh images). In some examples, the plurality of Walsh images obtained in the step 720 total N+1 (e.g., may occur when N=M). In some examples, the plurality of Walsh images obtained in the step 720 is stored by a control system, such as control system 522 in FIG. 5. In some examples, the plurality of Walsh images obtained in the step 720 is used to approximate the magnetic field component of an electromagnetic signal using reconstruction equation (e.g., using Equation 4). Based on the approximation, at least one characteristic of the electromagnetic signal may be determined (e.g., a spatial, a vectorial, and/or a temporal characteristic). However, a vectorial characteristic of the electromagnetic signal may be unable to be determined using the plurality of Walsh images obtained in the step 720 to approximate the magnetic field component of the electromagnetic signal. In some examples, the plurality of Walsh images obtained in the step 702 may be used to approximate the magnetic field component of an electromagnetic signal using a reconstruction equation (e.g., using Equation 4). The approximated magnetic field component of the electromagnetic signal may be used to determine the vectorial portion of the electromagnetic signal oriented in the α crystallographic orientation. The plurality of Walsh images obtained in the step 720 may be used to approximate magnetic field component of the electromagnetic signal using a reconstruction equation (e.g., using Equation 4). The approximated magnetic field component of the electromagnetic signal may be used to determine the vectorial portion of the electromagnetic signal oriented in the β crystallographic orientation. The approximation of the magnetic field component of the electromagnetic signal for the vectorial portion of the electromagnetic signal oriented in the α crystallographic orientation and the approximation of the magnetic field component of the electromagnetic signal for the vectorial portion of the electromagnetic signal oriented in the β crystallographic orientation may be used to determine at least one characteristic of the electromagnetic signal. In some examples, the two approximations may be used to determine the vectorial characteristic of the electromagnetic signal (e.g., all vector components of the electromagnetic signal). In some examples, the two approximations may determine a portion of the vectorial characteristic of the electromagnetic signal (e.g., some vector components of the electromagnetic signal).

A step 738 may include a plurality of quantum sensing processes performed on at least one nitrogen vacancy center defect with an γ crystallographic orientation, such as described in FIGS. 2A and 2B. The at least one nitrogen vacancy center defect with the γ crystallographic orientation may be represented by a qubit representation 740. As such, the pulse sequences in the quantum sensing processes of the step 738 are generated according to a carrier frequency of a resonant frequency associated with the γ crystallographic orientation. In some examples, the resonant frequency was determined using a method for determining one or more resonant frequencies, such as method 1250 of FIG. 12B. In some examples, the resonant frequency associated with the γ crystallographic orientation is determined when the resonant frequency associated with the β crystallographic orientation and the resonant frequency associated with the α crystallographic orientation is determined using a method for determining one or more resonant frequencies, such as method 1250 of FIG. 12B. In some examples, the resonant frequency associated with the γ crystallographic orientation is previously known or determined.

The step 738 may include a first pulse sequence representation 742 which may represent performing a quantum sensing process using pulse sequences generated according to a Walsh function with order m=0. The quantum sensing process using a Walsh function with order m=0 may yield a first Walsh image (or a plurality of first Walsh images), which may be represented in the step 738 by a first measurement representation 744. The step 738 may then repeat a pulse sequence representation 746 followed by a measurement representation 748 for N iterations 750, such that after the N iterations 750, N+1 Walsh images (or N+1 pluralities of Walsh images) may have been obtained. The pulse sequence representation 746 may represent performing a quantum sensing process using a Walsh function with a Walsh order m=i. For each iteration of the N iterations 750, the Walsh order associated with the pulse sequence representation 746 may increase by an integer. For instance, the Walsh order may increase by 1 for each iteration of the N iterations 750 up to a Walsh order N of the Nth iteration of the N iterations 750. The N of the N iterations 750 may be any integer greater than 0 and less than or equal to M, where M may be the largest Walsh order. Following the N iterations 750, the step 738 may include a final pulse sequence representation 752, and the final pulse sequence representation 752 may represent performing a quantum sensing process using a Walsh function with a Walsh order m=M. The quantum sensing process with the Walsh function of Walsh order m=M may yield a final Walsh image (or a plurality of final Walsh images), which may be represented in the step 738 by a final measurement representation 754.

The plurality of Walsh images obtained in the step 738 may total N+2 (e.g., N+2 Walsh images or N+2 pluralities of Walsh images). In some examples, the plurality of Walsh images obtained in the step 738 total N+1 (e.g., may occur when N=M). In some examples, the plurality of Walsh images obtained in the step 738 is stored by a control system, such as control system 522 in FIG. 5. In some examples, the plurality of Walsh images obtained in the step 738 is used to approximate the magnetic field component of an electromagnetic signal using a reconstruction equation (e.g., using Equation 4). Based on the approximation, at least one characteristic of the electromagnetic signal may be determined (e.g., a spatial, a vectorial, and/or a temporal characteristic). However, a vectorial characteristic of the electromagnetic signal may be unable to be determined based on only the Walsh images obtained in the step 738. In some examples, the plurality of Walsh images obtained in the step 702 may be used to approximate the magnetic field component of an electromagnetic signal using a reconstruction equation (e.g., using Equation 4). The approximated magnetic field component of the electromagnetic signal may be used to determine the vectorial portion of the electromagnetic signal oriented in the α crystallographic orientation. The plurality of Walsh images obtained in the step 720 may be used to approximate magnetic field component of the electromagnetic signal using a reconstruction equation (e.g., using Equation 4). The approximated magnetic field component of the electromagnetic signal may be used to determine the vectorial portion of the electromagnetic signal oriented in the β crystallographic orientation. The Walsh images obtained in the step 738 may be used to approximate magnetic field component of the electromagnetic signal using a reconstruction (e.g., using Equation 4). The approximated magnetic field component of the electromagnetic signal may be used to determine the vectorial portion of the electromagnetic signal oriented in the γ crystallographic orientation. The approximation of the magnetic field component of the electromagnetic signal for the vectorial portion of the electromagnetic signal oriented in the α crystallographic orientation, the approximation of the magnetic field component of the electromagnetic signal for the vectorial portion of the electromagnetic signal oriented in the β crystallographic orientation, and the approximation of the magnetic field component of the electromagnetic signal for the vectorial portion of the electromagnetic signal oriented in the γ crystallographic orientation may be used to determine at least one characteristic of the electromagnetic signal. In some examples, the three approximations may be enough to determine the vectorial characteristic of the electromagnetic signal (e.g., all vector components of the electromagnetic signal). In some examples, the three approximations may determine a portion of the vectorial characteristic of the electromagnetic signal (e.g., some vector components of the electromagnetic signal).

A step 756 may include a plurality of quantum sensing processes performed on at least one nitrogen vacancy center defect with an δ crystallographic orientation, such as described in FIGS. 2A and 2B. The at least one nitrogen vacancy center defect with the δ crystallographic orientation may be represented by a qubit representation 758. As such, the pulse sequences in the quantum sensing processes of the step 756 are generated according to a carrier frequency of a resonant frequency associated with the δ crystallographic orientation. In some examples, the resonant frequency was determined using a method for determining one or more resonant frequencies, such as method 1250 of FIG. 12B. In some examples, the resonant frequency associated with the δ crystallographic orientation is determined when the resonant frequency associated with the γ crystallographic orientation, the resonant frequency associated with the β crystallographic orientation, and the resonant frequency associated with the α crystallographic orientation is determined using a method for determining one or more resonant frequencies, such as method 1250 of FIG. 12B. In some examples, the resonant frequency associated with the δ crystallographic orientation is previously known or determined.

The step 756 may include a first pulse sequence representation 760 which may represent performing a quantum sensing process using pulse sequences generated according to a Walsh function with order m=0. The quantum sensing process using a Walsh function with order m=0 may yield a first Walsh image (or a plurality of first Walsh images), which may be represented in the step 756 by a first measurement representation 762. The step 756 may then repeat a pulse sequence representation 764 followed by a measurement representation 766 for N iterations 768, such that after the N iterations 768, N+1 Walsh images (or N+1 pluralities of Walsh images) may have been obtained. The pulse sequence representation 764 may represent performing a quantum sensing process using a Walsh function with a Walsh order m=i. For each iteration of the N iterations 768, the Walsh order associated with the pulse sequence representation 764 may increase by an integer. For instance, the Walsh order may increase by 1 for each iteration of the N iterations 768 up to a Walsh order N of the Nth iteration of the N iterations 768. The N of the N iterations 768 may be any integer greater than 0 and less than or equal to M, where M may be the largest Walsh order. Following the N iterations 768, the step 756 may include a final pulse sequence representation 770, and the final pulse sequence representation 770 may represent performing a quantum sensing process using a Walsh function with a Walsh order m=M. The quantum sensing process with the Walsh function of Walsh order m=M may yield a final Walsh image (or a plurality of final Walsh images), which may be represented in the step 756 by a final measurement representation 772.

The plurality of Walsh images obtained in the step 756 may total N+2 (e.g., N+2 Walsh images or N+2 plurality of Walsh images). In some examples, the plurality of Walsh images obtained in the step 756 total N+1 (e.g., may occur when N=M). In some examples, the plurality of Walsh images obtained in the step 756 is stored by a control system, such as control system 522 in FIG. 5. In some examples, the plurality of Walsh images obtained in the step 756 is used to approximate the magnetic field component of an electromagnetic signal using a reconstruction equation (e.g., using Equation 4). Based on the approximation, at least one characteristic of the electromagnetic field may be determined (e.g., a spatial, a vectorial, and/or a temporal characteristic). However, a vectorial characteristic of the electromagnetic field may be unable to be determined based on only the Walsh images obtained in the step 756. In some examples, the plurality of Walsh images obtained in the step 702 may be used to approximate the magnetic field component of an electromagnetic signal using a reconstruction equation (e.g., using Equation 4). The approximated magnetic field component of the electromagnetic signal may be used to determine the vectorial portion of the electromagnetic signal oriented in the α crystallographic orientation. The plurality of Walsh images obtained in the step 720 may be used to approximate magnetic field component the electromagnetic signal using a reconstruction equation (e.g., using Equation 4). The approximated magnetic field component of the electromagnetic signal may be used to determine the vectorial portion of the electromagnetic signal oriented in the β crystallographic orientation. The plurality of Walsh images obtained in the step 738 may be used to approximate the magnetic field component of the electromagnetic signal using a reconstruction (e.g., using Equation 4). The approximated magnetic field component of the electromagnetic signal may be used to determine the vectorial portion of the electromagnetic signal oriented in the γ crystallographic orientation. The plurality of Walsh images obtained in the step 756 may be used to approximate the magnetic field component of the electromagnetic signal using a reconstruction equation (e.g., using Equation 4). The approximated magnetic field component of the electromagnetic signal may be used to determine the vectorial portion of the electromagnetic signal oriented in the δ crystallographic orientation. The approximation of the magnetic field component of the electromagnetic signal for the vectorial portion of the electromagnetic signal oriented in the α crystallographic orientation, the approximation of the magnetic field component of the electromagnetic signal for the vectorial portion of the electromagnetic signal oriented in the β crystallographic orientation, the approximation of the magnetic field component of the electromagnetic signal for the vectorial portion of the electromagnetic signal oriented in the γ crystallographic orientation, and the approximation of the magnetic field component of the electromagnetic signal for the vectorial portion of the electromagnetic signal oriented in the δ crystallographic orientation may be used to determine at least one characteristic of the electromagnetic signal. In some examples, the four approximations may determine the vectorial characteristic of the electromagnetic signal (e.g., all vector components of the electromagnetic signal).

A person of skill in the art will appreciate that the step 702, the step 720, the step 738, and the step 756 of the method 700 may be performed in any order. Additionally, a person of skill in the art will appreciate that the method 700 may instead weave the k orientations. For instance, the first pulse sequence representation 706 and the first measurement representation 708 of the step 702 may be followed by the first pulse sequence representation 724 and the first measurement representation 726 of the step 720, which may be followed by the first pulse sequence representation 742 and the first measurement representation 744 of the step 738, which may be followed by the first pulse sequence representation 760 and the first measurement representation 762 of the step 756, etc.

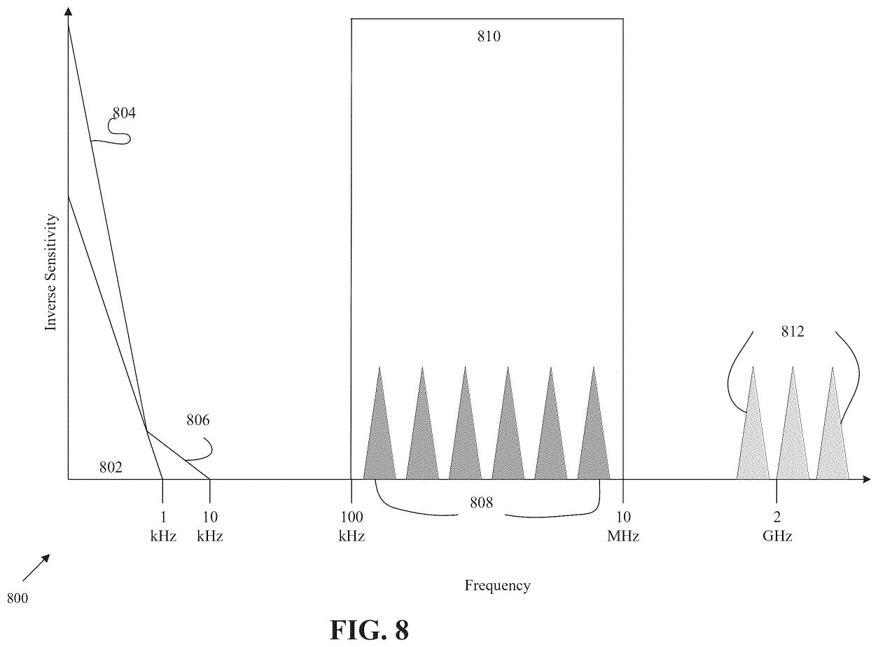

The quantum sensing processes and systems described herein may have a variety of technical advantages over conventional quantum sensing processes and systems. FIG. 8 plots the inverse sensitivity versus an electromagnetic signal's frequency 800 for a plurality of quantum sensing processes, specifically CW-ODMR 802, lock-in CW-ODMR 806, Ramsey 804, Hahn-Echo/Dynamical Decoupling 808, quantum sensing process 810, and Rabi 812, according to some examples. Unlike the CW-ODMR 802, the lock-in CW-ODMR 806, and the Ramsey 804 conventional quantum sensing processes, the quantum sensing process 810 may determine at least one characteristic of an electromagnetic signal with frequencies in a range of about 100 kHz to 10 MHz. Such a frequency range may allow the quantum sensing process 810 to contribute to applications like magnetic navigation, microelectronics fault detection, magnetic resonance imaging (MRI), and magnetocardiography. Although the maximum frequency characterizable via the quantum sensing process 810 may be smaller than the Rabi 812 conventional quantum sensing process, the quantum sensing process 810 may have a better sensitivity than the Rabi 812, such that the quantum sensing process 810 may characterize electromagnetic signals with smaller amplitudes and/or in more electromagnetically noisy environments. The quantum sensing process 810 may similarly have a better sensitivity than the Hahn-Echo/Dynamical Decoupling 808 conventional quantum sensing. Additionally, unlike the Hahn-Echo/Dynamical Decoupling 808 and the Rabi 812, the quantum sensing process 810 may characterize an arbitrary and/or unknown electromagnetic signal, which may allow the quantum sensing process 810 to contribute to applications largely inaccessible by the Hahn-Echo/Dynamical Decoupling 808 and the Rabi 812. As such, the quantum sensing process 810 may outperform some conventional quantum sensing processes, particularly for applications that may require spatial, temporal, and vectorial characterization of an unknown and arbitrary electromagnetic signal.

However, although not necessary, the performance of the quantum sensing processes and systems described herein may be further optimized via various optimization schemes. For instance, the sensitivity of the quantum sensing process may be improved via spatial and/or temporal optimization of the at least one pulse sequence (e.g., at least one pulse sequence 108 of FIG. 1A) applied to the at least one qubit (e.g., at least one qubit 114 of FIG. 1A) in the quantum sensing process and systems. In some examples, the spatial uniformity of the at least one pulse sequence across the sensing area (e.g., a field of view of the camera system, such as camera system 112 of FIG. 1A) is also optimized via the spatial and/or temporal optimization of the at least one pulse sequence applied to the at least one qubit and/or via a spatially optimized electromagnetic field generator.

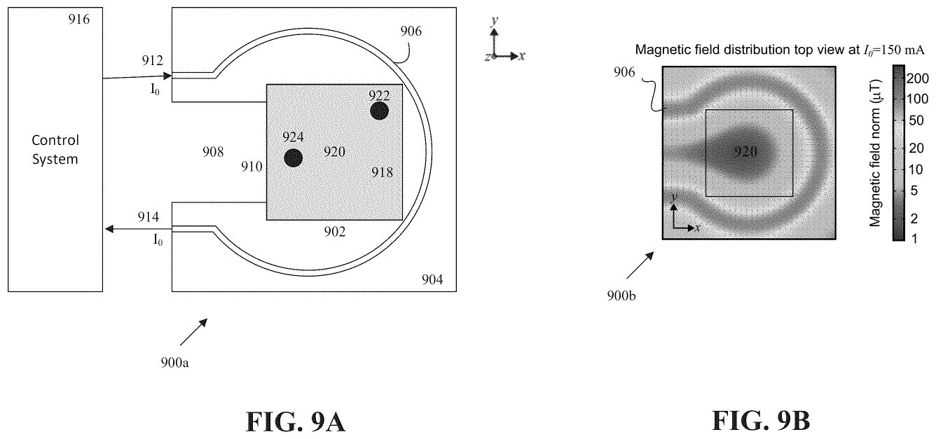

FIG. 9A illustrates a spatially optimized electromagnetic field generator 900a that is an exemplary embodiment of electromagnetic field generator 106 of FIG. 1 FIG. 1A. Exemplary spatially optimized electromagnetic field generator 900a may be a PCB 904 with a current (or voltage) trace 906 in an omega loop shape. The current trace 906 may have an input 912, and the input 912 may be connected to a control system 916, such that the electromagnetic field generator 900a may receive a command(s), instruction(s), trigger(s), etc. from the control system 916. The control system 916 is an exemplary embodiment of control system 104 of FIG. 1A. The current trace 906 of the electromagnetic field generator 900a may have an output 914, and the output 914 may be connected to ground, which may be a portion of the control system 916. A diamond solid-state host 902 may be positioned on the PCB 904 in the center 920 of the current trace 906. The diamond solid-state host 902 is an exemplary embodiment of at least one quantum probe 110 of FIG. 1A or diamond solid-state host 312 of FIG. 3. At least one qubit of the diamond solid-state host 902 may be at least one nitrogen vacancy center defect, for instance 922 and 924. The at least one nitrogen vacancy center defect (e.g., 922 and 924) is an exemplary embodiment of qubit 114 of FIG. 1A and nitrogen vacancy center defect 310 of FIG. 3. The PCB 904 may have a cutout 908, and the cutout 908 may allow laser light, such as laser light from laser 320 of FIG. 3 or laser light from laser 524 of FIG. 5, to illuminate the side 910 of the diamond solid-state host 902, such as described in FIG. 3.

Upon receiving the command(s), instruction(s), trigger(s), etc. from the control system 916, where the command(s), instruction(s), trigger(s), etc. may define at least one pulse sequence to be applied to the at least one nitrogen vacancy center defect (e.g., 922 or 924), the electromagnetic field generator 900a may output the at least one orthonormal electromagnetic field pulse sequence generated according to the at one pulse sequence. The at least one pulse sequence may be any pulse sequence described herein. The at least one orthonormal electromagnetic field pulse sequence may be any orthonormal electromagnetic field pulse sequence described herein. For instance, the electromagnetic field generator 900a may receive a plurality of time-ordered currents (e.g., current pulses, microwave pulses) that define the at least one pulse sequence. The plurality of time-ordered currents (e.g., current pulses, microwave pulses) may propagate through the current trace 906 and may induce the at least one orthonormal electromagnetic field pulse sequence generated according to the plurality of time-ordered currents. As such, spatial variations in the at least one orthonormal electromagnetic field pulse sequence may inadvertently alter the at least one orthonormal electromagnetic field pulse sequence applied to the at least one nitrogen vacancy center defect. For instance, for a defined pulse sequence A, spatial variations of an electromagnetic field pulse sequence generated according to the defined pulse sequence A may cause the electromagnetic field pulse sequence applied to the nitrogen vacancy center defect 922 to be inadvertently, unexpectedly, or uncontrollably different than the electromagnetic field pulse sequence applied to the nitrogen vacancy center defect 924. The spatial variations of the electromagnetic field pulse sequence (or orthonormal electromagnetic field pulse sequence) may alter the shape, amplitude, phase, Rabi frequency, etc. of pulses in the electromagnetic field pulse sequence (or orthonormal electromagnetic field pulse sequence).

The electromagnetic field generator 900a may reduce the spatial variations because the diamond solid-state host 902 may be confined to the PCB 904. Conventionally, the at least one pulse sequence of conventional quantum sensing systems and processes, such as those described in reference to FIG. 8, may be applied via a loop of wire positioned on a surface of a diamond solid-state host. Such a configuration may be unstable as the loop of wire can move relative to the surface of the diamond solid-state host. The inherent instability of this configuration may induce a spatially inhomogeneous output from the loop of wire. Conversely, the diamond solid-state host 902 may be confined to the PCB 904, such that the spatial inhomogeneity of the output of the electromagnetic field generator 900a may be reduced compared to the conventional loop of wire. FIG. 9B illustrates the spatial uniformity of an electromagnetic field 900b induced by a current of magnitude 150 mA applied to the input 912 of the electromagnetic field generator 900a. FIG. 9B may also illustrate that the spatial uniformity of the electromagnetic field 900b may be associated with the distance from the center 920 of the current trace 906. Additionally, FIG. 9B may illustrate that the magnitude of the electromagnetic field 900b may be associated with the distance from the center 920 of the current trace 906.

The spatial uniformity may be further improved with an electromagnetic field generator that includes a plurality of current traces. FIG. 10 illustrates a second spatially optimized electromagnetic field generator 1000a with a plurality of current traces. The electromagnetic field generator 1000a is an exemplary embodiment of electromagnetic field generator 106 of FIG. 1A. The electromagnetic field generator 1000a may be formed from a PCB 1002, and the PCB 1002 may have a plurality of current traces, for instance a first current trace 1004, a second current trace 1006, and a third current trace 1008. The first current trace 1004 may have an input 1010, which may be connected to a control system 1012, and an output 1014, which may be connected to ground (which may be a part of the control system 1012). The control system 1012 is an exemplary embodiment of control system 104 of FIG. 1A. The input 1010 may receive command(s), instructions(s), trigger(s), etc. from the control system 1012, and the command(s), instruction(s), trigger(s), etc. may propagate through the first current trace 1004. The second current trace 1006 may have an input 1016, which be connected to the control system 1012, and an output 1018, which may be connected to ground (which may be a part of the control system 1012). The input 1016 may receive command(s), instruction(s), trigger(s), etc. from the control system 1012, which may be the same or different than the command(s), instruction(s), trigger(s), etc. the input 1010 receives. The command(s), instruction(s), trigger(s), etc. the input 1016 received from the control system 1012 may propagate through the second current trace 1006. The third current trace 1008 may have an input 1020, which may be connected to a control system 1012, and an output 1022, which may be connected to ground (which may be a part of the control system 1012). The input 1020 may receive command(s), instruction(s), trigger(s), etc. from the control system 1012, and the command(s), instruction(s), trigger(s), etc. received at the input 1020 may be the same or different than the command(s), instruction(s), trigger(s), etc. the input 1010 and/or the input 1016 receives. The command(s), instruction(s), trigger(s), etc. the input 1020 received from the control system 1012 may propagate through the third current trace 1008.

The first current trace 1004, the second current trace 1006, and the third current trace 1008 may be fabricated on different layers of the PCB 1002. The PCB 1002 may include a cutout 1024, and the cutout 1024 may allow laser light from a laser, such as laser 320 of FIG. 3, to illuminate a side 1026 of a diamond solid-state host 1028, such as described in FIG. 3. The diamond solid-state host 1028 is an exemplary embodiment of quantum probe 110 of FIG. 1A or diamond solid-state host 312 of FIG. 3. The diamond solid-state host 1028 may be confined to the PCB 1002 and may be positioned in the center 1030 of the plurality of current traces. The first current trace 1004 may receive command(s), instruction(s), trigger(s), etc. from the control system 1012, and the command(s), instruction(s), trigger(s), etc. may define a first pulse sequence. The first pulse sequence may be any pulse sequence described herein. The second current trace 1006 may receive command(s), instruction(s), trigger(s), etc. from the control system 1012, and the command(s), instruction(s), trigger(s), etc. may define a second pulse sequence. The second pulse sequence may be any pulse sequence described herein. The second pulse sequence may be the same, or different, as the first pulse sequence. The third current trace 1008 may receive command(s), instruction(s), trigger(s), etc. from the control system 1012, and the command(s), instruction(s), trigger(s), etc. may define a third pulse sequence. The third pulse sequence may be any pulse sequence described herein. The third pulse sequence may be the same, or different, as the first pulse sequence and/or second pulse sequence. The first current trace 1004, the second current trace 1006, and the third current trace 1008 may propagate the received command(s), instruction(s), trigger(s), etc. through the respective traces, such that a first electromagnetic field pulse sequence (e.g., such as an orthonormal electromagnetic field pulse sequence) may be produced by the first current trace 1004, a second electromagnetic field pulse sequence (e.g., such as an orthonormal electromagnetic field pulse sequence) may be produced by the second current trace 1006, and a third electromagnetic field pulse sequence (e.g., such as an orthonormal electromagnetic field pulse sequence) may be produced by the third current trace 1008. The electromagnetic fields be generated according to their respective pulse sequences. The first, second, and third electromagnetic fields may linearly combine to form a net electromagnetic field, and the net electromagnetic field (e.g., such as an orthonormal electromagnetic field pulse sequence) may represent a net pulse sequence combined from the first, second, and third pulse sequences. The net electromagnetic field may be applied to at least one nitrogen vacancy center of the diamond solid-state host 1028. Due to the three current traces, the electromagnetic field generator 1000a may have more flexibility (e.g., more degrees of freedom) than the electromagnetic field generator 900a of FIG. 9A. For instance, the pulse sequences input to the current traces may be optimized, such that spatial variations of the net electromagnetic field (e.g., such as an orthonormal electromagnetic field pulse sequence) may be reduced. A person of skill in the art will appreciate that the circuit 1000a may be generalized to include more than three current traces.

The pulse sequences described herein, such as pulse sequence 108 of FIG. 1, pulse sequence 308 of FIG. 3, or pulse sequence 600 of FIG. 6, may be optimized using an optimization algorithm. For instance, each pulse sequence of pulse sequences 514, 546, 550, and 554 of FIG. 5 may be optimized using the optimization algorithm. In some examples, the pulse sequences 514, 546, 550, and 554 are optimized using the optimization algorithm for each iteration of the N iterations 596 of FIG. 5. In some examples, each pulse sequence refers to a subset of pulse sequences. For instance, each pulse sequence may be each pulse sequence of pulse sequences 514 and/or 546 (e.g., a subset of the pulse sequences 514, 546, 550, and 554) of FIG. 5. For instance, the optimization algorithm may include constructing a cost function in terms of parameters W of the at least one pulse sequence to be inputted into any electromagnetic field generator described herein. In some examples, the optimization algorithm is performed using a control system, such as control system 104 of FIG. 1A. The parameters W may be any parameter(s) associated with the at least one pulse sequence, for instance an amplitude, timing, duration, shape, etc. associated with a plurality of pulses in the at least one pulse sequence. To learn the optimal parameters W*, the cost function

$${l}_{α}^{φ} [ W ]$$

may be minimized. The cost function may be associated with the sensitivity

$${η}_{m}^{k}$$

(e.g., such as described in reference to Equation 6) and error (e.g., such as described in reference to Equation 7) of the quantum sensing processes and systems described herein.

For instance, the cost function may be of the form:

$${λ}_{1} ( {\int }_{0}^{∞} \frac{df}{{f}^{2}} S ( f ) {\vert {Y}_{α} ( f ; {θ}_{pulse} ) \vert}^{2} - log \vert {ϕ}_{α} ( {θ}_{pulse} ) \vert ) + {λ}_{2} ( log \vert {ϕ}_{α} ( {θ}_{pulse} ) \vert - {ϕ}_{α}^{target} ) , \qquad Equation 5$$

where λ₁ and λ₂ are regularization constants associated with the sensitivity and error, respectively, and may be selected by a user, S(f) is the noise power spectral density, a is an element in the basis that is orthonormal in time (or frequency), θₚᵤₗₛₑ is a set of weights parameterizing the at least one pulse sequence (e.g., such as weights associated with a neural network), f is the frequency of noise present in the quantum sensing system, and Y_{α}(f; θₚᵤₗₛₑ) is the Fourier transform of a filter function from the basis that is orthonormal in time (or frequency). φ_{α}(θₚᵤₗₛₑ) may be derived using Equation 2 or may be electromagnetic radiation emitted by at least one qubit (e.g., such as any qubit described herein) and measured via a camera system (e.g., such as any camera system described herein), such that the emitted electromagnetic radiation represents accumulated phase and the accumulated phase represents the projection of a known electromagnetic signal of form b(r,t) along a filter function inherent to at least one orthonormal electromagnetic field pulse sequence applied to the at least one qubit (e.g., such as described in reference to the quantum sensing systems and processes described herein). In Equation 5,

$${ϕ}_{α}^{target}$$

may similarly be derived using Equation 2 or may be the electromagnetic radiation expected to be emitted by the at least one qubit and measured via the camera system if no noise is present in the quantum sensing system. As such, the optimal parameters W* may be derived by minimizing Equation 5, such that φ_{α}(θₚᵤₗₛₑ) may be derived from a Walsh image, or a final image, (or a plurality of Walsh images, or final images) associated with the known electromagnetic signal that is obtained from performing the quantum sensing processes described herein. Thus, the optimization algorithm using the cost function (e.g., using Equation 5) may calibrate the quantum sensing systems and processes described herein by deriving or outputting a set of optimized pulse sequences using a known electromagnetic signal.

The cost function may be minimized with a gradient descent-based method. For instance, the cost function minimization may be of the form:

$${W}^{*} = arg {min}_{W} {l}_{α}^{φ} [ W ]$$

Such as described in reference to Equation 5, the optimal parameters W* may form at least one optimal pulse sequence. As such, an orthonormal electromagnetic field pulse sequence (e.g., the output of an electromagnetic field generator) generated according to the at least one optimal pulse sequence may have an optimized spatial uniformity. For instance, a control system, such as control system, 104 of FIG. 1A, may use the optimal parameters W* (e.g., outputs of the optimization algorithm) to adjust a time-ordered plurality of current (or voltage) pulses, such that the adjusted time-ordered plurality of current (or voltage) pulses define at least one optimal pulse sequence. The control system may then provide the adjusted time-ordered plurality of current (or voltage) pulses to an electromagnetic field generator, which may any electromagnetic field generator described herein. The electromagnetic field generator may then output at least one orthonormal electromagnetic field pulse sequence generated according to the at least one optimal pulse sequence. The orthonormal electromagnetic field pulse sequence may exhibit enhanced spatial uniformity across a surface of a quantum probe, such as quantum probe 110 of FIG. 1A. The orthonormal electromagnetic field pulse sequence may also, or instead of, enhance the sensitivity of at least one qubit to an electromagnetic signal, such that the at least one qubit can be used to determine at least one characteristic of an electromagnetic signal with a small amplitude and/or determine at least one characteristic of an electromagnetic signal in an electromagnetically noisy environment (e.g., large background noise). The at least one qubit may be any qubit described herein. In some examples, the sensitivity of a quantum sensing process and system to an electromagnetic signal may be optimized via reinforcement learning such as the reinforcement learning process 1100 described below. The reinforcement learning may be used to optimize the sensitivity of pixels of a camera used to capture a plurality of images, such that the optimization of the pixel sensitivity may tune at least a portion of an image in the plurality of images captured in the quantum sensing systems and processes described herein. For instance, a portion of the image having been tuned to have an optimized pixel sensitivity may have less background electromagnetic noise. The sensitivity

$${η}_{m}^{k}$$

of the pixels of an image r₀ (or the sensitivity per pixel of the image r₀) may be derived with the following equation:

$${η}_{m}^{k} ( {r}_{0} ) = \frac{{e}^{T / {T}_{2}}}{γ C \sqrt{T} \vert {ϕ}_{m}^{k} ( {r}_{0} ) \vert} \qquad Equation 6$$

where T₂ is the coherence time of the at least one qubit, C is the measurement contrast (e.g., derived from the emitted electromagnetic radiation of the at least one qubit), and

$${ϕ}_{m}^{k} ( {r}_{0} )$$

may be derived using Equation 2 or may be the electromagnetic radiation emitted by at the least one qubit (e.g., accumulated phase of the at least one qubit) and measured using a camera system (e.g., such as any camera system described herein).

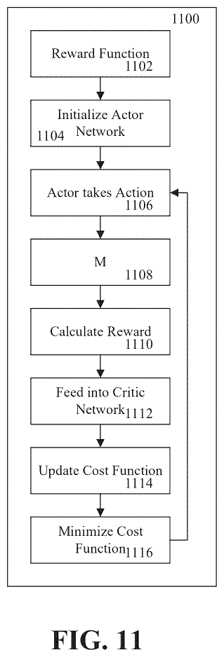

FIG. 11 illustrates an exemplary reinforcement learning process 1100 to optimize a per-pixel sensitivity, according to some examples. The reinforcement learning process 1100 may include a proximal policy optimization (PPO) algorithm or a deep deterministic policy gradient (DDPG) algorithm. A control system, such as control system 104, may be configured to perform reinforcement learning process 1100. The reinforcement learning process 1100 may iteratively learn a policy that optimizes the per-pixel sensitivity of a plurality of pixels of a camera, such as camera 332 of FIG. 3. The reinforcement learning process 1100 may iteratively alter one or more parameters of at least one pulse sequence applied to at least one qubit in the quantum sensing systems and processes described herein. The at least one pulse sequence may be any pulse sequence described herein. The at least one qubit may be any qubit described herein. For instance, the reinforcement learning process 1100 may adjust an amplitude, timing, duration, shape, etc. of one or more pulses in the at least one pulse sequence. As such, the control system may be configured to adjust one or more parameters of the at least one pulse sequence using the reinforcement learning process 1100. For instance, the control system may be configured to adjust timing, shape, frequency, phase, amplitude, etc. of a plurality of pulses in the at least one pulse sequence based on the reinforcement learning process 1100. In some examples, the one or more parameters of the at least one pulse sequence are associated with a current trace of an electromagnetic field generator, such as electromagnetic field generator 1000a of FIG. 10. For instance, the control system may be configured to adjust one or more parameters of the at least one pulse sequence received by each current trace of the electromagnetic field generator 1000a. As such, it may be relevant to optimize the at least one pulse sequence applied to each current trace using the reinforcement learning process 1100. The adjustments of the one or more parameters of the at least one pulse sequence may lead to at least one optimized pulse sequence. As such, applying the at least one optimized pulse sequence to the at least one qubit may ultimately yield an image or a plurality of images in which at least one portion of the image or each image in the plurality of images exhibits enhanced per-pixel sensitivity.

In step 1102, a reward function may be defined. The reward function may be associated with the per-pixel sensitivity (e.g., such as derived using Equation 6) and/or error of the quantum sensing processes and systems described herein. The error may be determined with:

$${\vert \text{?} r , t ) - b ( r , t ) \vert}^{2} , \qquad Equation 7$$

where [symbol] (r,t) is an approximation of the magnetic field component of a known electromagnetic signal of the form b(r,t). As such, the error, determined by performing the quantum sensing systems and processes described herein with the known electromagnetic signal, may calibrate (e.g., set a lower limit of) the error of the quantum sensing systems and processes described herein that determine at least one characteristic of an unknown and arbitrary electromagnetic signal.

The reward function may calculate the cumulative expected reward (e.g., present and future) after the reinforcement learning process 1100 produces an action from observing a state (e.g., one or more final images or one or more Walsh images) in the environment (e.g., quantum sensing systems described herein). The outputs of the selected reward function may be between 0 and 1, such that a 0 output may be associated with a high per-pixel sensitivity and a 1 output may be associated with a low per-pixel sensitivity. In some examples, defining the reward function in step 1102 includes a user selecting the reward function from one or more reward functions pre-defined in the control system. For instance, the control system may include a pre-defined reward function associated with the per-pixel sensitivity, a pre-defined reward function associated with the error, and a pre-defined reward function associated with the per-pixel sensitivity and the error of the quantum sensing systems and processes described herein, and a user may select from among the pre-defined reward functions. Optionally, defining the reward function in step 1102 includes the control system loading the reward function from memory. In some examples, the reward function is a default reward function that is obtained from memory without interaction of a user, and a user may or may not select a different reward function or modify the default reward function. In some examples, step 1102 is not performed and a pre-defined reward function is used by the control system for performing method 1100.

In step 1104, an actor network (e.g., a recurrent neural network) may be initialized, such that initialization of the actor network may include randomly selecting a set of weights of the actor network. In step 1106, the actor network takes an action by producing a set of pulse sequences (e.g., such as pulse sequence 108 of FIG. 1A) which are parameterized by the weights of the actor network. The set of pulse sequences may be used in the quantum sensing systems and processes described herein (e.g., the actor network takes an action). In step 1108, a Walsh image, or a final image, (or a plurality of Walsh images, or final images) may be obtained from performing the quantum sensing processes with the set of pulse sequences, such as described in method 500 of FIG. 5 or method 700 of FIG. 7. In step 1110, the sensitivity and/or error may be computed, and the reward function may calculate the reward. In step 1112, the reward and observed state (e.g., set of Walsh images or final images) may feed into the critic network, which may update a value function to assess the action taken in the step 1106. In step 1114, the critic and actor networks may then update a cost function, which may be a different cost function than the cost function described in reference to the optimization algorithm (e.g., Equation 5). For instance, the cost function for the reinforcement learning, such as the reinforcement learning process 1100, may be of the form:

$${𝔼}_{{s}_{t} \sim {ρ}^{β} , {a}_{t} \sim β , {r}_{t} \sim E} [ {( Q ( {s}_{t} , {a}_{t} \vert {θ}^{Q} ) - r ( {s}_{t} , {a}_{t} ) - γ Q ( {s}_{t + 1} , μ ( {s}_{t + 1} ) \vert {θ}^{Q} ) )}^{2} ] ,$$

where [symbol] is the expectation (e.g., expectation value of terms in the bracket), t is a timestep (e.g., such as a repetition of the reinforcement learning process 1100), sₜ are action pairs (e.g., observation, such as one or more Walsh/final images, and action pair), aₜ is an action (e.g., such as the action described in step 1106), β is a stochastic behavior policy, rₜ is a scalar reward, E is the environment in which the observations are made (e.g., such as quantum sensing systems and processes described herein), y is a discounting factor (e.g., γ∈[0,1]), and ρ^{β} is a discounted state visitation distribution for the stochastic behavior policy β. Q(sₜ, aₜ|θ^{Q}) is the action value function parameterized by θ^{Q} (e.g., such as the value function described in step 1112), r(sₜ, aₜ) is the reward function (e.g., such as the reward function described in step 1102), and Q(sₜ₊₁,μ(sₜ₊₁)|θ^{Q}) is the action value function parameterized by θ^{Q} (e.g., such as the value function described in step 1112) and associated with the next timestep t+1 and a greedy policy μ(sₜ₊₁).

In step 1116, the cost function may then be minimized (e.g., using a gradient descent-based method) with respect to the weights of both the critic and actor networks. The actor may then take another action (e.g., step 1106) and the steps 1108-1116 may be repeated. The steps 1106-1116 may be repeated until the expected future discounted sum of rewards is maximized (e.g., sum of rewards may reach or exceed a pre-determined threshold). The set of actions (e.g., such as the set of at) that sufficiently maximize the sum of rewards may represent a set of optimized pulse sequences which may be used in the quantum sensing systems and processes described herein that determine at least one characteristic of an unknown and arbitrary electromagnetic signal.

For instance, the set of optimized pulse sequences associated with Walsh functions and having a carrier frequency associated with a k orientation of at least one nitrogen vacancy center defect may yield a Walsh image with an optimized sensitivity (e.g., enhanced sensitivity) when the optimized pulses sequences are used in a quantum sensing process described herein. In some examples, the optimized pulse sequences may yield a Walsh image with portions of the Walsh image exhibiting optimized sensitivity.

The optimized pulse sequence and/or the weights of the critic and actor networks may be stored in a control system, such as any control system described herein. To optimize a pulse sequence with a Walsh function of a different Walsh order and/or a pulse sequence for the at least one nitrogen vacancy center defected oriented in a different crystallographic orientation, the reinforcement learning process 1100 may be repeated. For instance, the reinforcement learning process 1100 may be used to optimize all pulse sequences described in reference to FIG. 7. The reinforcement learning process 1100 may be used to optimize all pulse sequences used to generate the net orthonormal electromagnetic field pulse sequence, such as described in reference to FIG. 10. In some examples, the reinforcement learning process 1100 may be used to optimize pulse sequences while a quantum sensing process, such as the quantum sensing processes described herein, is performed (e.g., in real-time). This set of optimized pulse sequences may be stored in the control system. In some examples, using a set of optimized pulse sequences in a quantum sensing process and system may yield a Walsh image, or a plurality of Walsh images, with at least one portion of the Walsh image (or the plurality of Walsh images) exhibiting optimized sensitivity. Based on the optimal Walsh image, or the plurality of optimal Walsh images, the magnetic field component of an electromagnetic signal, such as any electromagnetic signal described herein, may be approximated with a reconstruction equation (e.g., with Equation 4). A person of skill in the art will appreciate that the optimized pulse sequences can be generated according to any basis that is orthonormal in time (or frequency), such that using the optimized pulse sequences in a quantum sensing process and system may yield an image, or a plurality of images, with at least one portion of the image, or the plurality of images, exhibiting optimized sensitivity. Based on the optimized image, or the plurality of optimized images, the magnetic field component of an electromagnetic field, such as any electromagnetic signal described herein, may be approximated with a reconstruction equation (e.g., with Equation 1).

FIG. 12A illustrates an exemplary method 1200 for determining at least one characteristic of an electromagnetic signal, according to some examples. The exemplary method 1200 may be utilized by any quantum sensing system or quantum sensing process described herein, for instance quantum sensing system 100 of FIG. 1A, quantum sensing system 300 of FIG. 3, quantum sensing process 500 of FIG. 5, or quantum sensing process described in FIG. 7.

In step 1202, a resonant frequency of at least one qubit of at least one quantum probe is determined. The at least one qubit may be any qubit described herein, for instance the at least one qubit 114 of FIG. 1A. The at least one quantum probe may be any quantum probe described herein, for instance the at least one quantum probe 110 of FIG. 1A. In some examples, a plurality of resonant frequencies are determined in step 1202.

FIG. 12B illustrates a method 1250 for determining one or more quantum state frequencies of at least one qubit of at least one quantum probe, according to step 1202. The at least one qubit may be any qubit described herein. For instance, the at least one qubit may be the at least one qubit 114 of FIG. 1A or the nitrogen vacancy center defect 200a of FIG. 2A. The at least one quantum probe may be any quantum probe described herein. For instance, the at least one quantum probe may be the at least one quantum probe 110 of FIG. 1A or a diamond's carbon lattice structure 206 of FIG. 2A.

In step 1252, a static magnetic field B may be applied to the at least one qubit of the at least one quantum probe. The static magnetic field B may be applied by any static magnetic field source configured to generate and apply the static magnetic field B, such as static magnetic field source 314 of FIG. 3. The static magnetic field B may split quantum states of the at least one qubit depending on the magnitude and direction of the static magnetic field B, such as described in reference to FIG. 2B. For instance, the static magnetic field may split the |mₛ=±1 [symbol] of the at least one nitrogen vacancy center defect 200a of FIGS. 2A and 2B. The magnitude of the split of the quantum states induced by the static magnetic field B may be estimated with 2γB, where γ is the gyromagnetic ratio of the at least one qubit (e.g., approximately 28.7 GHZ/T for a nitrogen vacancy center defect) and B is the magnitude of the static magnetic field B. The one or more quantum state frequencies of the at least one qubit may be associated with the splitting of the quantum states from the static magnetic field B, such as described in reference to FIG. 2B.

In step 1254, a calibration electromagnetic field pulse sequence having a carrier frequency of a possible resonant frequency i is applied to the at least one qubit of the at least one quantum probe. The calibration electromagnetic field pulse sequence may be applied using an electromagnetic field generator, such as electromagnetic field generator 106 of FIG. 1A. A control system, such as control system 104 of FIG. 1A, may control the electromagnetic field generator to generate the at least one calibration electromagnetic field pulse sequence. For instance, the control system may provide a time-ordered plurality of current (or voltage) pulses to the electromagnetic field generator, resulting in the electromagnetic field generator generating the calibration electromagnetic field pulse sequence. The time-ordered plurality of current (or voltage) pulses may be defined by a CW-ODMR pulse sequence or a pulsed ODMR pulse sequence. Thus, the calibration electromagnetic field pulse sequence may be generated according to a CW-ODMR pulse sequence or a pulsed ODMR pulse sequence.

Applying the calibration electromagnetic field pulse sequence having the possible resonant frequency i to the at least one qubit may switch the at least one qubit from a first quantum state to one or more second quantum states. The first quantum state may be a ground-energy state, such as state 216 of FIG. 2B. The one or more second quantum states may be any quantum state with a larger energy than the first quantum state, such as states 218, 242, 236, 230, 224, 226, 232, 238, or 244 of FIG. 2B. If the possible resonant frequency i corresponds to a energy difference between the first quantum state and the one or more second quantum states, then applying the calibration electromagnetic field pulse sequence switches the at least one qubit from the first quantum state to the one or more second quantum states. Thus, the possible resonant frequency i is a resonant frequency of the at least one qubit. If the possible resonant frequency i does not correspond to a energy difference between the first quantum state and the one or more second quantum states, then applying the calibration electromagnetic field pulse sequence does not switch the at least one qubit from the first quantum state to the one or more second quantum states. Thus, the possible resonant frequency i is not a resonant frequency of the at least one qubit.

The possible resonant frequency i may be associated with the magnitude of the split of the quantum states induced by magnetic field B, α crystallographic orientation of the at least one qubit, and a zero-field splitting, which is a energy difference between quantum states when the static magnetic field B is 0. For the nitrogen vacancy center defect 200a of FIG. 2A, the zero-field splitting is the frequency energy between the state 216 and the state 218 of FIG. 2A when the static magnetic field B 220 of FIG. 2A is not present. The zero-field splitting for the nitrogen vacancy center defect 200a of FIG. 2A is approximately equal to 2.87 GHz.

In some examples, the possible resonant frequency i is in a range of about 2.45 GHz to 3.25 GHz, for instance 2.45 GHz, 2.47 GHz, 2.49 GHz, 2.51 GHz, 2.53 GHZ, 2.55 GHz, 2.57 GHz, 2.59 GHz, 2.61 GHz, 2.63 GHZ, 2.65 GHz, 2.67 GHz, 2.69 GHz, 2.71 GHz, 2.73 GHz, 2.75 GHz, 2.77 GHz, 2.79 GHz, 2.81 GHz, 2.83 GHZ, 2.85 GHz, 2.87 GHz, 2.89 GHz, 2.91 GHz, 2.93 GHZ, 2.95 GHz, 2.97 GHz, 2.99 GHz, 3.01 GHz, 3.03 GHz, 3.05 GHz, 3.07 GHz, 3.09 GHz, 3.11 GHz, 3.15 GHz, 3.17 GHz, 3.19 GHz, 3.21 GHz, 3.23 GHz, or 3.25 GHz. In some examples, the possible resonant frequency i is greater than or equal to 2.45 GHz, 2.47 GHz, 2.49 GHz, 2.51 GHz, 2.53 GHZ, 2.55 GHz, 2.57 GHz, 2.59 GHz, 2.61 GHz, 2.63 GHz, 2.65 GHz, 2.67 GHz, 2.69 GHz, 2.71 GHz, 2.73 GHz, 2.75 GHz, 2.77 GHz, 2.79 GHz, 2.81 GHz, 2.83 GHZ, 2.85 GHz, 2.87 GHz, 2.89 GHz, 2.91 GHz, 2.93 GHZ, 2.95 GHz, 2.97 GHz, 2.99 GHz, 3.01 GHz, 3.03 GHz, 3.05 GHz, 3.07 GHz, 3.09 GHz, 3.11 GHz, 3.15 GHz, 3.17 GHz, 3.19 GHz, 3.21 GHz, 3.23 GHz, or 3.25 GHz. In some examples, the possible resonant frequency i is less than or equal to 2.45 GHz, 2.47 GHZ, 2.49 GHz, 2.51 GHz, 2.53 GHZ, 2.55 GHz, 2.57 GHz, 2.59 GHz, 2.61 GHz, 2.63 GHz, 2.65 GHz, 2.67 GHz, 2.69 GHz, 2.71 GHz, 2.73 GHz, 2.75 GHz, 2.77 GHz, 2.79 GHz, 2.81 GHz, 2.83 GHZ, 2.85 GHz, 2.87 GHz, 2.89 GHz, 2.91 GHz, 2.93 GHZ, 2.95 GHz, 2.97 GHz, 2.99 GHz, 3.01 GHz, 3.03 GHZ, 3.05 GHz, 3.07 GHz, 3.09 GHz, 3.11 GHz, 3.15 GHz, 3.17 GHz, 3.19 GHz, 3.21 GHz, 3.23 GHz, or 3.25 GHz. In some examples, the possible resonant frequency i is in a range of about 2.87 GHz−2γB−1 GHz to 2.87 GHz+2γB+1 GHz.

In step 1256, emission of electromagnetic radiation of the at least one qubit in response to the application of the calibration electromagnetic field pulse sequence in step 1254 is captured. In some examples, the emission of electromagnetic radiation is captured during step 1254. The emission of the electromagnetic radiation may be triggered by a control system, such as control system 104 of FIG. 1A, by illuminating the at least one qubit with light. For instance, the control system may provide a command, instruction, trigger, etc. to a laser, such as laser 320 of FIG. 3. The laser may illuminate the at least one qubit with laser light in response to the command, instruction, trigger, etc. provided by the control system.

The emitted electromagnetic radiation may be captured by a camera system, such as camera system 112 of FIG. 1A or camera system 326 of FIG. 3. For instance, a photodetector in the camera system, such as photodetector 330 in the camera system 326 of FIG. 3, may capture a magnitude of emitted electromagnetic radiation. The emitted electromagnetic radiation captured by the camera system may be received, stored, and/or displayed by the control system. The magnitude of the emitted electromagnetic radiation may be associated with whether the application of the calibration electromagnetic field pulse sequence of step 1254 switched the at least one qubit from the first quantum state to the one or more second quantum states. For instance, if the calibration electromagnetic field pulse sequence switched the at least one qubit, then the magnitude of the emitted electromagnetic radiation is smaller than if the calibration electromagnetic field pulse sequence did not switch the at least one qubit. As such, the magnitude of the emitted electromagnetic radiation is associated with the possible quantum frequency i. Thus, by varying the possible quantum frequency i of the calibration electromagnetic field pulse sequence, the one or more quantum state frequencies of the at least one qubit can be determined. As such, step 1254 and step 1256 may be repeated, such that for each iteration 1260 of step 1254 and step 1256, the possible resonant frequency i may be changed. A plurality of iterations 1260 of step 1254 and the step 1256 may yield a plurality of captured emitted electromagnetic radiation, such that each captured emitted electromagnetic radiation of the plurality may correspond to a calibration electromagnetic field pulse sequence having a different possible resonant frequency i.

In a step 1258, the one or more resonant frequencies are determined using the plurality of captured emitted electromagnetic radiation. The plurality of captured emitted electromagnetic radiation may be used to form a plot of the magnitude of the emitted electromagnetic radiation versus the possible resonant frequency i. The plot may be formed using the control system. The plot may have one or more inverse peaks with nonzero linewidths at one or more possible quantum state frequencies. The one or more possible quantum state frequencies of the one or more inverse peaks may be the one or more quantum state frequencies. A user may visually determine the one or more quantum state frequencies using the location of the inverse peaks in the plot. The user may then input the one or more quantum state frequencies into the control system for later use, such as for generating the at least one pulse sequence 108 using control system 104 of FIG. 1A. In some examples, the control system applies a fit to the peaks or otherwise processes the plot and/or peaks to determine the one or more quantum state frequencies. The control system may then store the one or more quantum state frequencies for later use, such as for generating the at least one pulse sequence 108 of FIG. 1.

Referring to the method 1200 of FIG. 12A, in some examples, the method 1200 may include receiving or otherwise obtaining one or more resonant frequencies, such that the step 1202 may not be performed. For instance, the one or more resonant frequencies may be one or more previously known frequencies (e.g., previously determined). In some examples, the step 1202 may be performed prior to a quantum sensing process, such as quantum sensing process 500 of FIG. 5. In some examples, the step 1202 may be performed prior to method 700 of FIG. 7.

In step 1204, at least one pulse sequence is applied to the at least one qubit. The at least one pulse sequence may be any pulse sequence described herein, such as the at least one pulse sequence 108 of FIG. 1A or pulse sequence 600 of FIG. 6. For instance, the at least one pulse sequence may have a carrier frequency of the resonant frequency determined in step 1202 using method 1250 of FIG. 12B. The at least one pulse sequence may include a plurality of pulses and the plurality of pulses may be associated with a filter function from a basis that is orthonormal in time (or frequency). The plurality of pulses may have a duration in accordance with a Rabi frequency of the at least one qubit.

FIG. 12C illustrates a method 1280 for determining a Rabi frequency of at least one qubit of at least one quantum probe, which may be relevant for determining a duration of a plurality of pulses of a pulse sequence, such as the at least one pulse sequence 108 of FIG. 1A or pulse sequence 600 of FIG. 6. The at least one qubit may be any qubit described herein. For instance, the at least one qubit may be the at least one qubit 114 of FIG. 1A or the nitrogen vacancy center defect 200a of FIG. 2A. The at least one quantum probe may be any quantum probe described herein. For instance, the at least one quantum probe may be the at least one quantum probe 110 of FIG. 1A or a diamond's carbon lattice structure 206 of FIG. 2A.

In step 1282, a resonant frequency of the at least one qubit is determined, such as with method 1250 of FIG. 2B. In step 1284, the at least one qubit is initialized to a first quantum state (e.g., ground-energy state, such as state 216 of FIG. 2B) by illuminating the at least one qubit with light. For instance, a control system (e.g., such as control system 104 of FIG. 1A) may provide a command, instruction, trigger, etc. to a laser, such as laser 320 of FIG. 3. The laser may illuminate the at least one qubit with laser light in response to the command, instruction, trigger, etc. provided by the control system. In step 1286, a calibration circuit generated pulse sequence having a carrier frequency of a resonant frequency of the at least one qubit and a pulse duration i is applied to the at least one qubit of the at least one quantum probe. The calibration circuit generated pulse sequence may be applied using a circuit, such as circuit 106 of FIG. 1A. A control system, such as control system 104 of FIG. 1A, may control the circuit to generate the at least one calibration circuit generated pulse sequence. For instance, the control system may provide a time-ordered plurality of current (or voltage) pulses to the circuit, resulting in the circuit generating the calibration circuit generated pulse sequence. The time-ordered plurality of current (or voltage) pulses may be defined by a Rabi pulse sequence. Thus, the calibration circuit generated pulse sequence may be generated according to a Rabi pulse sequence.

Applying the calibration circuit generated pulse sequence having the resonant frequency of the at least one qubit and varying the pulse duration i causes the at least one qubit to oscillate between a first quantum state and a second quantum state associated with the resonant frequency. The first quantum state may be a ground-energy state, such as state 216 of FIG. 2B. The second quantum states may be any quantum state with a larger energy than the first quantum state, such as states 218, 242, 236, 230, 224, 226, 232, 238, or 244 of FIG. 2B. The frequency of the oscillation is the Rabi frequency of the at least one qubit.

In step 1288, emission of electromagnetic radiation of the at least one qubit in response to the application of the calibration circuit generated pulse sequence in step 1256 is captured. The emission of the electromagnetic radiation may be triggered by a control system, such as control system 104 of FIG. 1A, by illuminating the at least one qubit with light. For instance, the control system may provide a command, instruction, trigger, etc. to a laser, such as laser 320 of FIG. 3. The laser may illuminate the at least one qubit with laser light in response to the command, instruction, trigger, etc. provided by the control system.

The emitted electromagnetic radiation may be captured by a camera system, such as camera system 112 of FIG. 1A or camera system 326 of FIG. 3. For instance, a photodetector in the camera system, such as photodetector 330 in the camera system 326 of FIG. 3, may capture a magnitude of emitted electromagnetic radiation. The emitted electromagnetic radiation captured by the camera system may be received, stored, and/or displayed by the control system. The magnitude of the emitted electromagnetic radiation may be associated with the oscillation of the at least one qubit between the first quantum state and the second quantum state of step 1286. For instance, if the calibration circuit generated pulse sequence with a pulse duration i caused the at least one qubit to oscillate to the second quantum state, then if the at least one qubit is at the first quantum state. As such, the magnitude of the emitted electromagnetic radiation is associated with the pulse duration i. Thus, by varying the pulse duration i of the calibration circuit generated pulse sequence, the Rabi frequency of the at least one qubit can be determined (e.g., the oscillation between the first quantum state and the second quantum state). As such, steps 1254-step 1258 may be repeated, such that for each iteration 1292, the pulse duration i may be changed. A plurality of iterations 1292 of step 1284-step 1286 may yield a plurality of captured emitted electromagnetic radiation, such that each captured emitted electromagnetic radiation of the plurality may correspond to a calibration circuit generated pulse sequence having a different pulse duration i.

In step 1290, the Rabi frequency is determined using the plurality of captured emitted electromagnetic radiation. The plurality of captured emitted electromagnetic radiation may be used to form a plot of the magnitude of the emitted electromagnetic radiation versus the pulse duration i. The plot may be formed using the control system. The plot may have oscillations, and the Rabi frequency is the oscillation. In some examples, the pulse duration associated with a half-period oscillation (e.g., a maximum to a minimum magnitude of the emitted electromagnetic radiation or a minimum to a maximum magnitude of the emitted electromagnetic radiation) is also determined. The pulse duration associated with a half-period oscillation may be relevant for determining a duration of a plurality of pulses of a pulse sequence, such as the at least one pulse sequence 108 of FIG. 1A or pulse sequence 600 of FIG. 6A. For instance, the pulse duration associated with a half-period oscillation may be the ideal duration of a π-pulse in pulse sequence 600 of FIG. 6A. A user may visually determine the Rabi frequency and/or the pulse duration associated with the half-period oscillation. The user may then input the Rabi frequency and/or the pulse duration associated with the half-period oscillation into the control system for later use, such as for generating the at least one pulse sequence 108 using control system 104 of FIG. 1A. In some examples, the control system applies a fit to the oscillations or otherwise processes the plot to determine the Rabi frequency and/or the pulse duration associated with the half-period oscillation. The control system may then store the Rabi frequency and/or the pulse duration associated with the half-period oscillation for later use, such as for generating the at least one pulse sequence 108 of FIG. 1.

Referring to the method 1200 of FIG. 12A, the at least one pulse sequence may be generated using a control system, such as control system 104 of FIG. 1A. The control system may control an electromagnetic field generator, which may be any electromagnetic field generator described herein, to generate at least one orthonormal electromagnetic field pulse sequence according to the at least one pulse sequence. The electromagnetic field generator may be configured to apply the at least one orthonormal electromagnetic field pulse sequence to the at least one qubit of the at least one quantum probe. As such, applying the at least one orthonormal electromagnetic field pulse sequence generated according to the at least one pulse sequence may constitute applying the at least one pulse sequence to the at least one qubit of the at least one quantum probe. The at least one orthonormal electromagnetic field pulse sequence is applied while an electromagnetic signal from an electromagnetic signal-generating system is present. The electromagnetic signal-generating system may be any electromagnetic signal-generating system described herein, such as electromagnetic signal-generating system 102 of FIG. 1A. The electromagnetic signal may be any electromagnetic signal described herein, such as electromagnetic signal 504 of FIG. 5.

The production of the electromagnetic signal from the electromagnetic signal-generating system may correspond with applying the at least one orthonormal electromagnetic field pulse sequence. The application of the at least one orthonormal electromagnetic field pulse sequence may cause the at least one qubit to accumulate phase representing a projection of the electromagnetic signal onto a filter function inherent to the at least one orthonormal electromagnetic field pulse sequence (e.g., phase measurement associated with coefficients of the filter function). For each application of the at least one orthonormal electromagnetic field pulse sequence, the electromagnetic signal is produced again, such that at least one characteristic of the electromagnetic signal is consistent for each application of the at least one orthonormal electromagnetic field pulse sequence (e.g., at least one characteristic of the electromagnetic signal is consistent for each production, or triggering, of the electromagnetic signal by the electromagnetic signal-generating system). For instance, the at least one characteristic of the electromagnetic signal that is consistent may be an amplitude characteristic (e.g., the electromagnetic signal is produced with a consistent amplitude) or a phase characteristic (e.g., the electromagnetic signal is produced with a consistent phase). Step 1204 may be further described in reference to at least FIGS. 1, 3, and 5.

In step 1206, a plurality of images of electromagnetic radiation emitted by the at least one qubit after applying the at least one pulse sequence to the at least one qubit is captured. The plurality of images may be captured by a camera system, such as camera system 112 of FIG. 1A. The emitted electromagnetic radiation may represent the phase accumulated by the at least one qubit. The control system may be configured to control the camera system. For instance, the control system may control when the plurality of images is captured, the duration of image capture, the phase of each image in the plurality of images, etc. The control system may receive, store, display, or otherwise process the plurality of images. In some examples, an image of the emitted electromagnetic radiation is captured. In some examples, a plurality of images is combined to form a final image, such as described in quantum sensing process 500 of FIG. 5 or method 700 of FIG. 7. For instance, an image with a positive in-phase phase, an image with a negative in-phase phase, an image with a positive quadrature phase, and an image with a negative quadrature phase may be combined to form a final image, such as described in quantum sensing process 500 of FIG. 5. In some examples, step 1204 and step 1206 may be repeated for one or more iterations, such as described in quantum sensing process 500 and method 700 of FIG. 7. For each iteration in the one or more iterations, the filter function associated with the at least one pulse sequence of the step 1204 may be changed, such as described in quantum sensing process 500 or method 700 of FIG. 7. In some examples, after one or more iterations of step 1204 and step 1206, the resonant frequency (e.g., carrier frequency) associated with the at least one pulse sequence of step 1204 may be changed, such as described in step 720, 738, and 756 of method 700 of FIG. 7. Step 1204 and step 1206 may then be repeated for one or more iterations using the changed carrier frequency, such as described in method 700 of FIG. 7. Step 1206 may be further described in reference to at least FIGS. 1, 3, 5, and 7.

In step 1208, at least one characteristic of the electromagnetic signal is determined based on the plurality of images. For instance, the control system may determine the coefficients spanning the basis that is orthonormal in time (or frequency) using the emitted electromagnetic radiation in the plurality of images. With the coefficients determined, a reconstruction equation (e.g., using Equation 1 or Equation 4) may be used by the control system to approximate the magnetic field component of the electromagnetic signal. From the approximated magnetic field component of the electromagnetic signal, at least one characteristic of the electromagnetic signal may be determined using the control system. The at least one characteristic may be a spatial characteristic, a temporal characteristic, or a vectorial characteristic. The step 1208 may be further described in reference to at least FIGS. 1, 3, 5, and 7.

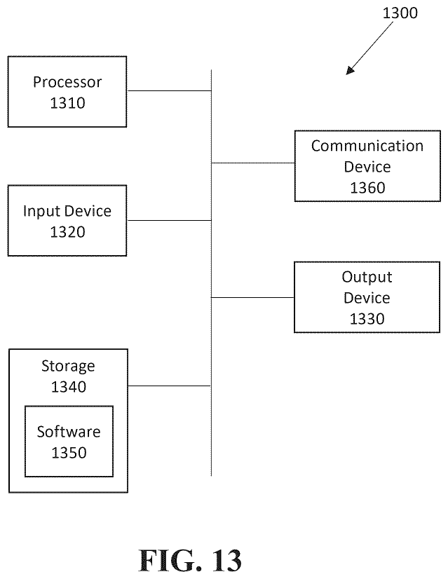

FIG. 13 illustrates an example of a computing system 1300 that may be used for any one of the computing systems and devices described herein, such as for control system 104 of FIG. 1A. System 1300 can be a computer connected to a network. System 1300 can be a client computer, a server, a router, a hub, an access point, or any other computing device that can send and/or receive wireless signals or non-wireless signals. As shown in FIG. 13, system 1300 can be any suitable type of microprocessor-based system, such as a personal computer, workstation, server, or handheld computing device (portable electronic device) such as a phone or tablet. The system can include, for example, one or more of a processor 1310, input device 1320, output device 1330, storage 1340, and communication device 1360. Input device 1320 and output device 1330 can generally correspond to those described above and can either be connectable or integrated with the computer.

Input device 1320 can be any suitable device that provides input, such as a touch screen, keyboard or keypad, mouse, gesture recognition component of a virtual/augmented reality system, or voice recognition device. Output device 1330 can be or include any suitable device that provides output, such as a touch screen, haptics device, virtual/augmented reality display, or speaker.

Storage 1340 can be any suitable device that provides storage, such as an electrical, magnetic, or optical memory, including a RAM, cache, hard drive, removable storage disk, or other non-transitory computer-readable medium. In some examples, the storage 1340 may include GPUs configured to handle high memory requirements and parallel computation, for instance for use in reinforcement learning, such as the reinforcement learning process 1100 of FIG. 11. Communication device 1360 can include any suitable device capable of transmitting and receiving signals over a network, such as a network interface chip or device. The components of the computer can be connected in any suitable manner, such as via a physical bus or wirelessly.

Software 1350, which can be stored in storage 1340 and executed by processor 1310, can include, for example, the programming that embodies the functionality of the present disclosure (e.g., as embodied in the devices as described above). For example, software 1350 can include one or more programs for performing one or more of the steps of method 1200 of FIG. 12, method 1250 of FIG. 12B, or method 700 of FIG. 7.

Software 1350 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1340, that can contain or store programming for use by or in connection with an instruction execution system, apparatus, or device.

Software 1350 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

System 1300 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 1300 can implement any operating system suitable for operating on the network. Software 1350 can be written in any suitable programming language, such as C, C++, Java, or Python. In various aspects, application software embodying the functionality of the present disclosure can be deployed in different configurations, such as in a client/server arrangement or through a Web browser as a Web-based application or Web service, for example.

The foregoing description, for the purpose of explanation, has been described with reference to specific aspects. However, the illustrative discussions above are not intended to be exhaustive or to limit the invention to the precise forms disclosed. Many modifications and variations are possible in view of the above teachings. The aspects were chosen and described in order to best explain the principles of the techniques and their practical applications. Others skilled in the art are thereby enabled to best utilize the techniques and various aspects with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosures of the patents and publications referred to in this application are hereby incorporated herein by reference.

1. A method for determining at least one characteristic of an electromagnetic signal using a quantum probe, the method comprising:
determining a resonant frequency of at least one qubit of at least one quantum probe;
applying at least one pulse sequence to the at least one qubit, wherein the at least pulse sequence has a carrier frequency of the resonant frequency and is associated with a filter function that comprises an orthonormal basis;
capturing a plurality of images associated with electromagnetic radiation emitted by the at least one qubit after applying the at least one pulse sequence to the at least one qubit; and
determining at least one characteristic of the electromagnetic signal based on the plurality of images.

2. The method of claim 1, wherein the orthonormal basis comprising the filter function is a Walsh basis.

3. The method of claim 1, wherein the at least one characteristic of the electromagnetic signal comprises a spatial characteristic, a temporal characteristic, and a vectorial characteristic.

4. The method of claim 1, comprising triggering the electromagnetic signal in correspondence with application of the at least one pulse sequence.

5. The method of claim 4, comprising repeatedly triggering the electromagnetic signal using at least one characteristic that is consistent for different triggerings of the electromagnetic signal.

6. The method of claim 1, wherein the at least one quantum probe comprises at least one diamond solid-state host and the at least one qubit of the at least one diamond solid-state host comprises at least one nitrogen vacancy center defect, at least one silicon vacancy defect, or at least one tin vacancy defect.

7. A system for determining at least one characteristic of an electromagnetic signal, the system comprising:
at least one qubit of at least one quantum probe, wherein the at least one qubit has a resonant frequency;
an electromagnetic field generator configured to apply at least one pulse sequence to the at least one qubit, wherein the at least one pulse sequence has a carrier frequency of the resonant frequency and is associated with a filter function that comprises an orthonormal basis;
a camera system configured to capture a plurality of images associated with electromagnetic radiation emitted by the at least one qubit after applying the at least one pulse sequence to the at least one qubit; and
a control system configured to:
control the electromagnetic field generator to apply the at least one pulse sequence to the at least one qubit,
control the camera system to capture the plurality of images,
receive the plurality of images from the camera system, and
determine at least one characteristic of the electromagnetic signal based on the plurality of images received.

8. The system of claim 7, wherein the orthonormal basis comprising the filter function is a Walsh basis.

9. The system of claim 7, wherein the control system is configured to adjust at least one parameter of the at least one pulse sequence based on an output of an optimization algorithm.

10. The system of claim 9, wherein adjusting the at least one parameter of the at least one pulse sequence tunes a spatial uniformity of the at least one pulse sequence applied to the at least one qubit.

11. The system of claim 9, wherein adjusting the at least one parameter of the at least one pulse sequence tunes a sensitivity of the at least one qubit to the electromagnetic signal.

12. The system of claim 7, wherein the camera system comprises a lock-in camera.

13. The system of claim 12, wherein the plurality of images captured by the lock-in camera comprise:
an image associated with a positive in-phase phase, an image associated with a negative in-phase phase, an image associated with a positive quadrature phase, and an image associated with a negative quadrature phase.

14. The system of claim 7, wherein the control system is configured to adjust at least one parameter of the at least one pulse sequence based on an output from reinforcement learning, wherein adjusting the at least one parameter tunes at least one portion of an image.

15. The system of claim 7, wherein the at least one characteristic of the electromagnetic signal determined by the control system comprises a spatial characteristic, a temporal characteristic, and a vectorial characteristic.

16. The system of claim 7, comprising triggering the electromagnetic signal in correspondence with application of the at least one pulse sequence.

17. The system of claim 16, comprising repeatedly triggering the electromagnetic signal using at least one characteristic that is consistent for different triggerings of the electromagnetic signal.

18. The system of claim 17, wherein the at least one characteristic of the electromagnetic signal that is consistent for different triggerings of the electromagnetic signal comprises an amplitude characteristic or a phase characteristic.

19. The system of claim 7, wherein the at least one quantum probe comprises at least one diamond solid-state host.

20. The system of claim 19, wherein the at least one qubit of the diamond solid-state host comprises at least one nitrogen vacancy center defect, at least one silicon vacancy defect, or at least one tin vacancy defect.
